(19) United States
(12) Patent Application Publication
(10) Pub. No.: US 2016/0110381 A1
(43) Pub. Date: Apr. 21, 2016

(54) METHODS AND SYSTEMS FOR SOCIAL MEDIA-BASED PROFILING OF ENTITY LOCATION BY ASSOCIATING ENTITIES AND VENUES WITH GEO-TAGGED SHORT ELECTRONIC MESSAGES

(71) Applicant: FUJI XEROX CO., LTD., TOKYO (JP)

(72) Inventors: FRANCINE CHEN, MENLO PARK, CA (US); DHIRAJ JOSHI, FREMONT, CA (US)

(73) Assignee: FUJI XEROX CO., LTD.

(21) Appl. No.: 14/517,791

(22) Filed: Oct. 17, 2014

(51) Int. Cl. G06F 17/30

(52) U.S. Cl. CPC G06F 17/30241; G06F 17/3087

(57) ABSTRACT

A method includes: obtaining from a first social media source a new short unstructured electronic message with an associated geographic location and message content; identifying a first venue name and a first visit characteristic from the message content; accessing a database of venues, wherein the database includes for respective venues a venue name, a geographic location and one or more venue characteristics, wherein information in the database reflects information associated with the respective venues extracted from a plurality of social media posts, including a plurality of prior short unstructured electronic messages from the first social media source; determining whether the database includes a candidate venue that has a venue name and geographic location that respectively are substantially similar to the first venue name and the associated geographic location; when the candidate venue exists in the database, associating the new short unstructured electronic message with the candidate venue and perform updates.

### TECHNICAL FIELD

The present application generally describes obtaining, managing, and providing electronic content and, more particularly methods and systems for obtaining, managing, using, and providing geo-tagged Internet content aggregated from one or more providers.

### BACKGROUND

There has been a growth in Internet content as users flock to numerous social networking sites. These sites provide platforms for users to engage with each other by uploading and creating content in the form of commentary, pictures, status updates, etc. There has also been a growth in the use of mobile devices that provide the ability to geo-tag content with a particular location. Geo-tagging is the process of adding geographical identification metadata. This metadata usually consists of latitude and longitude coordinates. Mobile devices may have a geolocator such as a Global Positioning System (GPS) to determine the location of the mobile devices. Using the geolocator, a user may take a picture or post a message with a mobile device, and the picture or the message may be “geo-tagged” with the geographic location where the picture was taken or the message was posted. This way, the picture and/or other content may later be referenced by the geographic location.

Many users utilize multiple social networking sites or other Internet platforms for sharing thoughts, opinions, and updates. As a result, the user content spreads among multiple sites with no cohesive way to mine this rich source of information. For example, the task of profiling entities based on the social media content is difficult for at least two reasons. First, the user content is often organized by user or topic, not by geographic location. It is difficult for businesses to profile at specific locations using public posts on social media. There is no easy way to compare stores within a chain at different locations. Second, the information across different chains for competitive analysis may spread among multiple sites. It is difficult to compare stores at different locations across chains of competitors.

### SUMMARY

The use of social media for sharing thoughts, opinions and updates about oneself with friends and the general public has been growing rapidly. In turn, these expressions are stored in public social media platforms and can serve as a rich source of information. The applications of mining this information are wide-ranging and include epidemiology, public opinion on political issues, event detection, and public opinion of businesses and their products. In addition to conventional methods for assessing customer satisfaction, such as questionnaires and comment forms, social media is rapidly becoming a widely-used method for expressing judgments about places. As a result, companies employ workers specifically to track comments and to address issues about their products on public forums and microblogs.

Traditional assessment of customer opinion using questionnaires and comment forms allows a merchant to understand opinion only about the stores in question. With social media, information about all stores is available to anyone. Thus a business can easily collect data, such as tweets (e.g., short messages from the Twitter service), about competitors as well as about themselves, and then mine the data to perform an assessment against their competitors. While forums such as TripAdvisor and Yelp allow users to post opinions about their experiences with businesses, using these forums requires more effort than sending a quick short unstructured electronic message, such as a microblog on Twitter. With Twitter and other short message services the casual opinions of many people are expressed.

The present invention is directed towards a system based on mining information from social media (e.g., from short unstructured electronic messages) for profiling entities, such as stores, schools, churches etc., at specific locations. The system matches geo-tagged short electronic messages, such as tweets from Twitter etc., against venues with associated locations from applications, such as Foursquare etc., to identify the specific entity mentioned in a short unstructured electronic message. Filtering of the short unstructured electronic messages is performed simultaneously where it is unclear which venue is being referred to. Clustering is used to group venues that represent the same entity. By linking geo-coordinates to places, the short unstructured electronic messages, such as tweets associated with an venue, can then be used to profile that business venue.

Examples of profiling a venue based on the matched short unstructured electronic messages includes the sentiment of at a given venue, and the social group size of users at a given venue. In some implementations, a sentiment estimator is used for tweets to create sentiment profiles of the stores in a chain, computing the average sentiment of tweets associated with each store. And in some implementations, in order to estimate social group size, photos contained in some short unstructured electronic message posts are analyzed to extract social group information. Sentiment profiling results can be visualized as sentiment heatmaps, which show how sentiment differs across stores in the same chain and how some chains have more positive sentiment than other chains. Heatmaps representing profiling results for social group size illustrate how the size of a social group can vary.

Systems, methods, devices, and non-transitory computer readable storage medium for social media-based profiling of entity location by associating entities and venues with geo-tagged short electronic messages are hereby disclosed. As used herein, an entity can be a location (such as a country, state, town, geographic region, or the like) or an organization (such as a corporation, institution, association, government or private organization, or the like), or other proper name which is typically capitalized in use to distinguish the named entity from an ordinary noun. Starbucks, McDonald's, Homestead High School, New Hope Church etc. are examples of entities. Also as used herein, a venue is any building or indoor or outdoor facility that is generally operated by an operator of the venue on a public or private basis, and to which guests may come for purposes such as but not limited to education, religion, entertainment, shopping, transportation and/or recreational. Examples of a venue include but are not limited to schools, church, stadiums, arenas, ballparks, theaters, amphitheaters, parks, recreational areas, gymnasiums, arcades, ice rinks, bowling alleys, stores, shopping centers, airports, train stations, bus terminals, truck stops, marinas, restaurants, resorts, landmarks, monuments, amusement parks and ski resorts etc.

In some implementations, a method for social media-based profiling of entity location by associating entities and venues with geo-tagged short electronic messages includes: at a computer system with one or more processors and memory storing instructions for execution by the processor, obtaining from a first social media source a new short unstructured electronic message with an associated geographic location and message content; identifying a first venue name and a first visit characteristic from the message content; accessing a database of venues, wherein the database includes for respective venues a venue name, a geographic location and one or more venue characteristics, wherein information in the database reflects information associated with the respective venues extracted from a plurality of social media posts, including a plurality of prior short unstructured electronic messages from the first social media source; determining whether the database includes a candidate venue that has a venue name and geographic location that respectively are substantially similar to the first venue name and the associated geographic location; when the candidate venue exists in the database, associating the new short unstructured electronic message with the candidate venue; and when venue records in the database are associated with more than a threshold number of new short unstructured electronic messages, updating the one or more venue characteristics of the venue records based on the first visit characteristics of the associated new short unstructured electronic messages.

In some implementations, the method further includes: when the candidate venue does not exist in the database, adding a new venue record to the database based on the first venue name, the associated geographic location and the first characteristic.

In some implementations, the first visit characteristic is at least one of a sentiment orientation or a group size.

In some implementations, determining whether the database includes a candidate venue that has a venue geographic location that is substantially similar to the associated geographic location; includes: determining whether distance between the venue geographic location and the associated geographic location is less than a predetermined distance.

In some implementations, the database includes for a respective venue a number of check-ins, a number of unique visitors, and a core venue indicator, the method further includes as a preliminary operation: obtaining from a first information source a first plurality of short unstructured electronic messages, each having an associated first geographic location and message content, wherein the message content includes the first venue name and one or more visit characteristics; obtaining from a second information source a second plurality of venue locations, each having an associated second geographic location and second venue name that is substantially similar to the first venue name; determining for each venue location in the second plurality whether each respective short message in the first plurality has an associated first geographic location that is within a predefined distance of the second geographic location associated with the each venue location; in response to the determining, associating with a venue in the database respective short messages and venue locations whose associated first and second geographic locations are within the predefined distance; applying a clustering algorithm to the database to cluster the venues into venue groups and filter out outliers, wherein the outliers represent one or more venues in the database that have one or more aggregate characteristics that are substantially different from corresponding aggregate characteristics of other venues in the database; identifying for each venue group a core venue that has most number of check-ins in the venue group; and updating the core venue indicator for the core venue. In some implementations, updating the venue record based on the first characteristics of the associated short unstructured electronic messages includes: for a venue group in the venue groups: tagging the associated short unstructured electronic messages with the core venue; and updating the venue record corresponding to the core venue based on the first characteristics of the associated short unstructured electronic messages.

In some implementations, updating the core venue record based on the first characteristics of the associated short unstructured electronic messages includes: for a venue group in the venue groups: tagging the associated short unstructured electronic messages with the core venue; and updating the core venue record corresponding to the core venue based on the first characteristics of the associated short unstructured electronic messages.

In some implementations, the method further includes: assigning sentiment orientations to the message content that recites comments about the venues, the sentiment orientations indicating whether the message content reflects a positive, neutral, or negative sentiment; classifying sentiment degree within a particular sentiment orientation; computing a sentiment score based on the sentiment orientations; and associating the sentiment score with the short unstructured electronic message.

In some implementations, the method further includes: for a venue group in the venue groups: identifying the core venue of the venue group; identifying the tagged short unstructured electronic messages associated with the core venue; computing an overall sentiment of the core venue based on sentiment scores associated with the tagged short unstructured electronic messages; and deriving a sentiment heatmap from the venue groups, the sentiment heatmap reflecting the overall sentiments towards each core venue and the venue name and the geographic location of each core venue.

In some implementations, deriving the sentiment heatmap includes: encoding an overall sentiment associated with a particular core venue using a distinctive visual characteristic, including one of: mark size, mark color and mark size and color.

In some implementations, the method further includes: determining whether a facial image is associated with the short unstructured electronic message; when the facial image exists: detecting the number of faces in the facial image; assigning the short unstructured electronic message to a size category based on the number of faces in the facial image; and associating the size category with the short unstructured electronic message.

In some implementations, the size category is one of a single person, a pair of people, a small group or a large group.

In some implementations, the method further includes: for a venue group in the venue groups: identifying a core venue of the venue group; identifying the tagged short unstructured electronic messages associated with the core venue; computing an average group size of the core venue based on size categories associated with the tagged short unstructured electronic messages; and deriving a social group size heatmap from the venue groups, the social group size heatmap reflecting the average group size visiting each core venue and the venue name and the geographic location of each core venue.

In some implementations, deriving the social group size heatmap includes: encoding an average social group size associated with a particular core venue using a distinctive visual characteristic, including one of: mark size, mark color and mark size and color.

In some implementations, the one or more aggregate characteristics include one or more of: a minimum number of visitors to the venue or a minimum number of short messages associated with the venue.

In some implementations, updating the one or more venue characteristics includes: accessing the database of venues, wherein the database includes for respective venues a venue name, a geographic location and one or more venue characteristics, wherein information in the database reflects information associated with the respective venues extracted from a plurality of social media posts, including a plurality of prior short unstructured electronic messages from the first social media source; locating core venues in the database; and recalculating the one or more venue characteristics of the core venues to include the first characteristics of the associated new short unstructured electronic messages.

In some implementations, a method of profiling venues includes: obtaining from a social media source a first plurality of short unstructured electronic messages, each having an associated first geographic location and message content, wherein the message content includes a first venue name and one or more visit characteristics; obtaining from an information source a second plurality of venue locations, each having an associated second geographic location and second venue name that is substantially similar to the first venue name; determining for each venue location in the second plurality whether each respective short message in the first plurality has an associated first geographic location that is within a predefined distance of the second geographic location associated with the each venue location; in response to the determining, associating in a database respective short messages and venue locations whose associated first and second geographic locations are within the predefined distance; and applying a clustering algorithm to the database to cluster the venues into venue groups and filter out outliers, wherein the outliers represent one or more venues in the database that have one or more aggregate characteristics that are substantially different from corresponding aggregate characteristics of other venues in the database; and when venue records in the database are associated with more than a threshold number of short unstructured electronic messages, updating the one or more venue characteristics of the venue records based on the first characteristics of the associated short unstructured electronic messages.

In some implementations, the one or more aggregate characteristics include one or more of: a minimum number of visitors to the venue or a minimum number of short messages associated with the venue.

In some implementations, the method of profiling venues further includes: for each venue group in a venue group, identifying a core venue based on the associated one or more visit characteristics.

In some implementations, the method of profiling further includes: accessing the database of venues, wherein the database includes for respective venues a venue name, a geographic location and one or more venue characteristics, wherein information in the database reflects information associated with the respective venues extracted from a plurality of social media posts, including a plurality of prior short unstructured electronic messages from the first social media source; locating core venues in the database; and recalculating the one or more venue characteristics of the core venues to include the first characteristics of the associated new short unstructured electronic messages.

In some implementations, a computer system for social media-based profiling of entity location by associating entities and venues with geo-tagged short electronic messages includes: one or more processors; memory; and one or more programs, wherein the one or more programs are stored in the memory and configured to be executed by the one or more processors, the one or more programs including instructions for: obtaining from a first social media source a new short unstructured electronic message with an associated geographic location and message content; identifying a first venue name and a first visit characteristic from the message content; accessing a database of venues, wherein the database includes for respective venues a venue name, a geographic location and one or more venue characteristics, wherein information in the database reflects information associated with the respective venues extracted from a plurality of social media posts, including a plurality of prior short unstructured electronic messages from the first social media source; determining whether the database includes a candidate venue that has a venue name and geographic location that respectively are substantially similar to the first venue name and the associated geographic location; when the candidate venue exists in the database, associating the new short unstructured electronic message with the candidate venue; and when venue records in the database are associated with more than a threshold number of new short unstructured electronic messages, updating the one or more venue characteristics of the venue records based on the first visit characteristics of the associated new short unstructured electronic messages.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram illustrating a computing system for profiling entities in accordance with some implementations.

FIG. 2A is a block diagram illustrating a server system in accordance with some implementations.

FIG. 2B is a block diagram illustrating a server database of venues in accordance with some implementations.

FIG. 3A is a block diagram illustrating a client device in accordance with some implementations.

FIG. 3B is a block diagram illustrating a device in accordance with some implementations.

FIG. 4A illustrates an example visualization of an entity (e.g. Starbucks) including three locations of the entity venues (blue) and the locations of short unstructured electronic messages where the entity name is mentioned (red) in accordance with some implementations.

FIG. 4B is an example of an entity location with multiple associated venues in accordance with some implementations.

FIG. 4C illustrates example results of clustering in accordance with some implementations.

FIG. 5A illustrates a variety of average sentiment values profiled for different Starbucks and Peet's Coffee & Tea store locations in accordance with some implementations.

FIG. 5B illustrates the comparison between two fast food burger chains, In-N-Out Burger with McDonald's in accordance with some implementations.

FIG. 5C illustrates the size of social groups visiting different venues in accordance with some implementations.

FIGS. 6A-6E illustrate a flow diagram of a method for social media-based profiling of entity location by associating entities and venues with geo-tagged short electronic messages in accordance with some implementations.

FIG. 7 illustrates a flow diagram of a method for profiling venues in accordance with some implementations.

FIGS. 8A-8B illustrate a flow diagram of a method for profiling venues in accordance with some implementations.

Like reference numerals refer to corresponding parts throughout the drawings.

### DESCRIPTION OF EMBODIMENTS

The implementations described herein provide techniques for matching geo-tagged, short unstructured messages (such as tweets) with venues (e.g., businesses, schools, parks, museums, etc.) at specific locations, and then mining information contained in or associated with the short messages at each venue location. For mining, some implementations estimate one or more visit characteristics expressed by authors in contents of messages about specific venues. For example, in some implementations, the visit characteristic is one or more of author sentiment about the venue (e.g., the degree to which the author liked or disliked the venue) and group size associated with a visit to the venue. Some implementations estimate the sentiment of tweet content using a sentiment analyzer 222 and estimate social group size by recognizing faces in photos using facial recognition software. Note that the descriptions of implementations provided herein may refer to tweets, short messages, short unstructured messages, instant messages, electronic messages, microblogs, posts or similar terms. All such references are intended to be interchangeable unless distinctions expressed or are made apparent by context (e.g., reference to a particular API for retrieving tweets that is provided by the Twitter service is context specific).

In some implementations, short unstructured electronic messages, such as tweets are collected for profiling entities. Some of these messages (and the number of such messages is growing) may be tagged with geo-coordinates. According to one researcher, as of August 2013, about 6% of Twitter users opt-in to broadcast their location. In some locations, an even larger proportion of people tag their tweets with geo-coordinates. For example, one research noted that out of 26 million tweets in New York City and Los Angeles, 7.57 million tweets, or about 29%, were GPS-tagged.

Geo-tagged tweets provide the longitude and latitude of the tweet; however, the actual place (e.g., the venue name) that a user is tweeting from is not provided. Although the geo-coordinates of places are available from cities for businesses and from dictionaries of geographic locations, the information is scattered, partially complete, and needs to be reconciled. A common approach to geo-based investigations is to use locations from the self-reported home locations of Twitter users, rather than the geolocation of each tweet. For example, one group of researchers used home locations, which were primarily cities. Another group of researchers mapped home locations to counties. A third group of researchers tagged Points of Interest (POI) in tweets, where the set of POI names are extracted from tweets associated with Foursquare check-ins. However, POI names that correspond to multiple locations, such as chain stores, were not disambiguated. And a fourth group of researchers visualized the happiness of individual geo-tagged tweets in New York City and the continental U.S. Similarly to the fourth approach, the present invention focuses on geo-tagged tweets. But in contrast, the present invention maps the tweets to specific businesses or venues.

In some implementations, Foursquare venues are chosen for identifying places. Foursquare venues are crowd-sourced places where users check-in. Examples of venue types include stores, stadiums, or points of interest, such as museums, schools, parks, etc. Each venue is associated with a latitude and longitude. Knowing the actual venue that is being tweeted about can provide much richer information about each of the venues in a collection of geo-tagged tweets.

There have been a number of works on identifying the location of a social media post when the post does not contain geolocation information. For example, from only tweet text, one group of researchers were able to place 51% of Twitter users within 100 miles of their actual home location. A second group of researchers used an ensemble of classifiers for city, state, and time-zone estimation of a user's home location. A third group of researchers created language models for Twitter to predict country, state, town, and zip code locations. And a fourth group of researchers used the GPS position of a user's friends to identify the user's location within 100 meters of their actual location with an accuracy of 84.3% when the locations of nine friends are used. The current accuracy of these methods is still too coarse for use in associating locations with venues; furthermore, none of these works associates locations with places or venues, such as stores, stadiums, or points of interest.

Photos have also been used for geolocation. For example, one group of researchers used gender-based models of Flickr tags to predict location, with a best accuracy of 21.5%, which is inadequate. A second group of researchers used the information in photos together with compass direction to perform localization. A third group of researchers used Support Vector Machines (SVMs) to predict the location of photos of landmarks based on visual, textual, and temporal features. And a fourth group of researchers employed visual nearest neighbors ranking to geo-locate a photo. However, even if geolocation performance is high, only a minority of tweets contain at least one photo. For example, in a geo-tagged Twitter corpus used to test implementations described herein, less than 4% of tweets contained an Instagram photo. In addition, not all photos are indicative of a user's location. We also looked at the Exchangeable Image File Format (EXIF) information associated with photos, and found that the geo-position information had been stripped. Thus, while geolocation based on photos can be helpful for some tweets, using photo-based methods alone is not sufficient.

Reference will now be made in detail to various implementations, examples of which are illustrated in the accompanying drawings. In the following detailed description, numerous specific details are set forth in order to provide a thorough understanding of the invention and the described implementations. However, the invention may be practiced without these specific details. In other instances, well-known methods, procedures, components, and circuits have not been described in detail so as not to unnecessarily obscure aspects of the implementations.

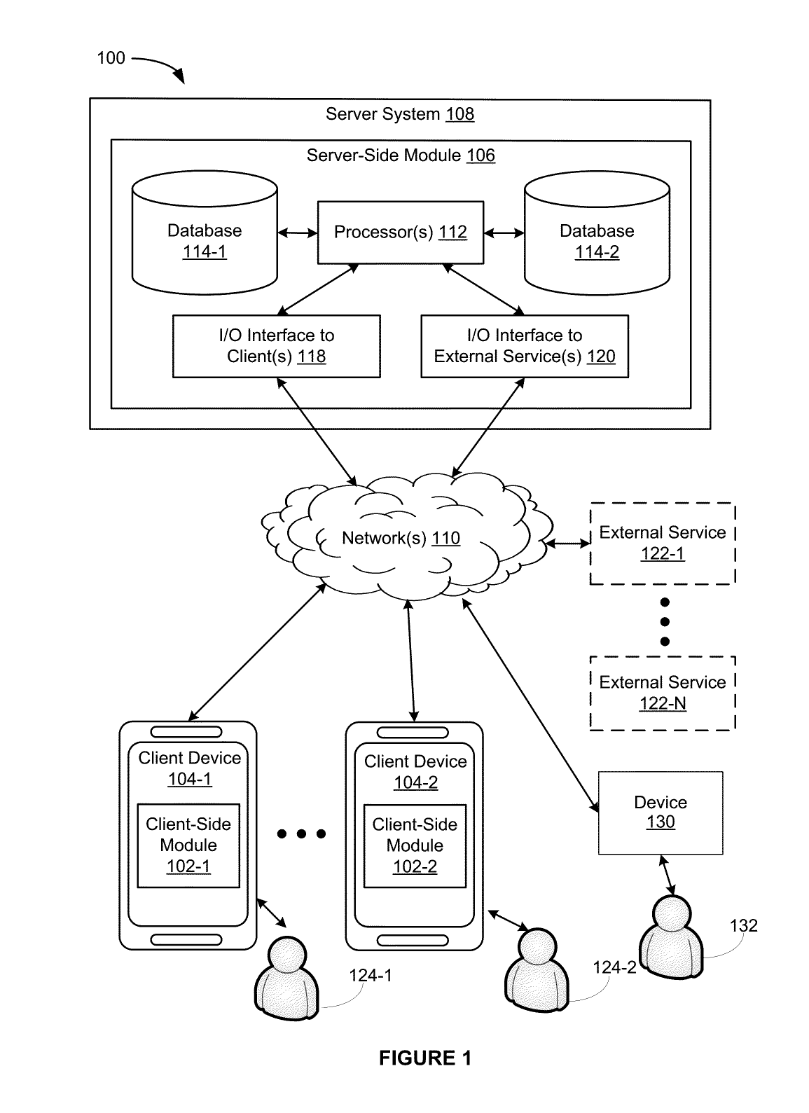

FIG. 1 is a block diagram illustrating a computer system 100 for social media-based profiling of entity location by associating entities and venues with geo-tagged short electronic message in accordance with some implementations. In some implementations, the computer system 100 includes client-side processing 102-1, 102-2 . . . (hereinafter “client-side module 102”) executed on client devices 104-1, 104-2 . . . , at least one end user device 130, and server-side processing 106 (hereinafter “server-side module 106”) executed on a server system 108. A client-side module 102 communicates with a server-side module 106 through one or more networks 110. The client-side module 102 provides client-side functionalities (e.g., instant messaging and access to social networking services) and communications with server-side module 106. Server-side module 106 provides server-side functionalities (e.g., instant messaging, and social networking services) for any number of client modules 102 each residing on a respective client device 104.

In some implementations, the client devices 104 are mobile devices such as laptops, smart phones etc., from which users 124 can execute messaging and social media applications that interact with external services 122, such as Twitter, Foursquare, and Facebook etc. The server 108 connects to the external services 122 to obtain the messages and the entity as well as venue data for profiling entities and venues.

The computer system 100 shown in FIG. 1 includes both a client-side portion (e.g., client-side module 102) and a server-side portion (e.g., server-side module 106). In some implementations, data processing is implemented as a standalone application installed on client device 104. In addition, the division of functionalities between the client and server portions of client environment data processing can vary in different embodiments. For example, in some implementations, client-side module 102 is a thin-client that provides only user-facing input and output processing functions, and delegates all other data processing functionalities to a backend server (e.g., server system 108).

The communication network(s) 110 can be any wired or wireless local area network (LAN) and/or wide area network (WAN), such as an intranet, an extranet, or the Internet. It is sufficient that the communication network 110 provides communication capability between the server system 108 and the clients 104, and the device 130.

In some implementations, the server-side module 106 includes one or more processors 112, one or more databases 114, an I/O interface to one or more clients 118, and an I/O interface to one or more external services 120. The I/O interface to one or more clients 118 facilitates the processing of input and output associated with the client devices and devices for server-side module 106. One or more processors 112 obtain short unstructured electronic messages from a plurality of users, process the short unstructured electronic messages, process location information of a client device, share location information of the client device to client-side modules 102 of one or more client devices, and store information for further entity profiling processing. The database 114 stores various information, including but not limited to, photos, geographic information, map information, service categories, service provider names, and the corresponding locations. The database 114 may also store a plurality of record entries relevant to the users associated with location sharing, and short electronic messages exchanged among the users for location sharing. I/O interface to one or more external services 120 facilitates communications with one or more external services 122 (e.g., other social network websites, merchant websites, credit card companies, and/or other processing services).

In some implementations, the server-side module 106 connects to the external services 120 through the I/O interfaces 120 and obtain information such as short unstructured electronic messages and venues gathered by the external services 120. After accumulating a number of short unstructured electronic messages and venues for profiling entities, the server 108 processes the data retrieved from the external services 120 to extract information such as location information of a client device when the short unstructured electronic messages were posted to the external services 120, and the share location information of the client device, among others. The processed and/or the unprocessed information are stored in the database 114, including but not limited to, photos, geographic information, map information, service categories, service provider names, and the corresponding locations. The database 114 may also store a plurality of record entries relevant to the users associated with location sharing, and short electronic messages exchanged among the users for location sharing.

Examples of the client device 104 include, but are not limited to, a handheld computer, a wearable computing device, a personal digital assistant (PDA), a tablet computer, a laptop computer, a cellular telephone, a smart phone, an enhanced general packet radio service (EGPRS) mobile phone, a media player, a navigation device, a portable gaming device console, or a combination of any two or more of these data processing devices or other data processing devices.

The client device 104 includes (e.g., is coupled to) a display and one or more input devices. The client device 104 receives inputs (e.g., messages, images) from the one or more input devices and outputs data corresponding to the inputs to the display for display to the user 124. The user 124 uses the client device 104 to transmit information (e.g., messages, images, and geographic location of the client device 104) to the server 108. The server 108 receives the information, processes the information, and sends processed information to the display of the client device 104 for display to the user 124.

Examples of the device 130 include, but are not limited to, a handheld computer, a wearable computing device, a personal digital assistant (PDA), a tablet computer, a laptop computer, a desktop computer, a cellular telephone, a smart phone, an enhanced general packet radio service (EGPRS) mobile phone, a media player, a navigation device, a game console, a television, a remote control, or a combination of any two or more of these data processing devices or other data processing devices.

The device 130 includes (e.g., is coupled to) a display and one or more input devices. The device 130 receives inputs (e.g., requests to retrieve profiling information, messages, images) from the one or more input devices and outputs data corresponding to the inputs to the display for display to the user 132. The user 132 uses the device 130 to transmit information (e.g., requests to retrieve profiling information, messages, images, and geographic location of the device 130) to the server 108. The server 108 receives the information, processes the information, and sends processed information (e.g., profiling result) to the display of the client device 130 for display to the user 132.

Examples of one or more networks 110 include local area networks (LAN) and wide area networks (WAN) such as the Internet. One or more networks 110 are, optionally, implemented using any known network protocol, including various wired or wireless protocols, such as Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

The server system 108 is implemented on one or more standalone data processing apparatuses or a distributed network of computers. In some implementations, the server system 108 also employs various virtual devices and/or services of third party service providers (e.g., third-party cloud service providers) to provide the underlying computing resources and/or infrastructure resources of the server system 108.

The computer system 100 shown in FIG. 1 includes both a client-side portion (e.g., the client-side module 102, modules on the device 130) and a server-side portion (e.g., the server-side module 106). In some implementations, a portion of the data processing is implemented as a standalone application installed on the client device 104 and/or the end user device 130. In addition, the division of functionalities between the client and server portions of client environment data processing can vary in different implementations. For example, in some implementations, the client-side module 102 is a thin-client that provides user-facing input and output processing functions, and delegates data processing functionalities to a backend server (e.g., the server system 108).

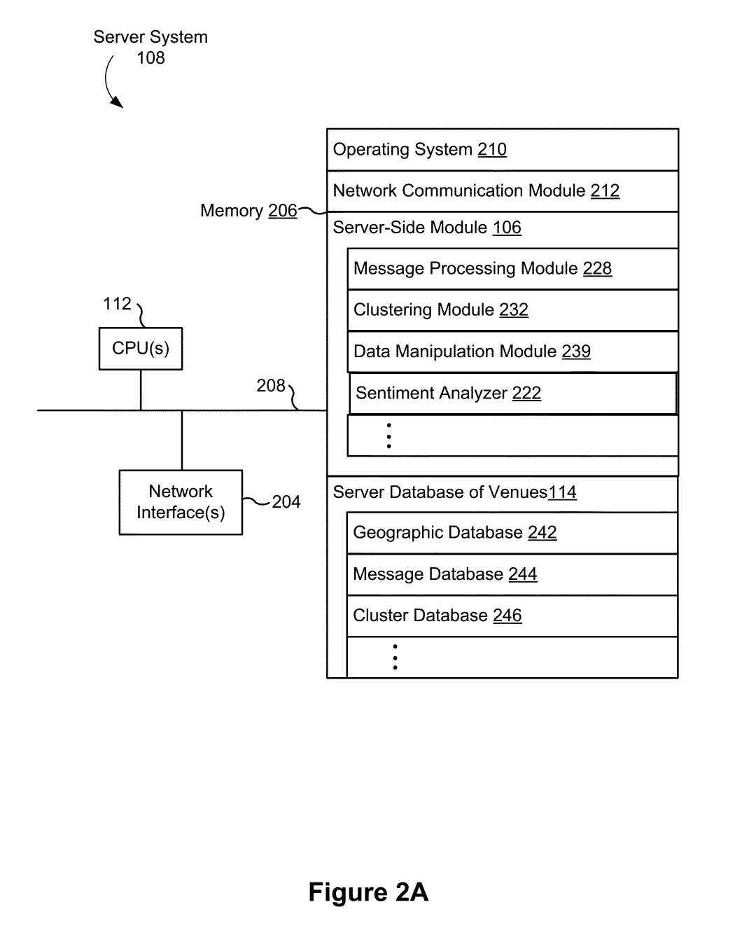

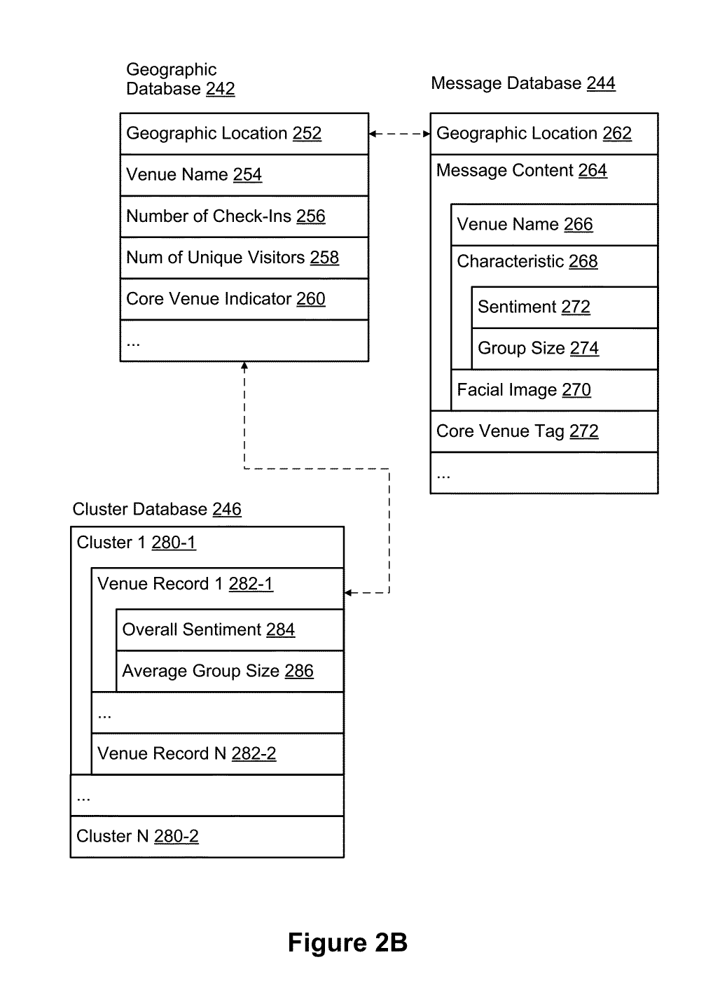

FIG. 2A is a block diagram illustrating the server system 108 in accordance with some implementations. The server system 108 may include one or more processing units (CPUs) 112, one or more network interfaces 204 (e.g., including an I/O interface to one or more clients 118 and an I/O interface to one or more external services 120), one or more memory units 206, and one or more communication buses 208 for interconnecting these components (e.g. a chipset).

The memory 206 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory 206, optionally, includes one or more storage devices remotely located from one or more processing units 112. The memory 206, or alternatively the non-volatile memory within the memory 206, includes a non-transitory computer readable storage medium. In some implementations, the memory 206, or the non-transitory computer readable storage medium of the memory 206, stores the following programs, modules, and data structures, or a subset or superset thereof:
operating system 210 including procedures for handling various basic system services and for performing hardware dependent tasks;
network communication module 212 for connecting server system 108 to other computing devices (e.g., client devices 104 and external service(s) 122) connected to one or more networks 110 via one or more network interfaces 204 (wired or wireless);
server-side module 106, which provides server-side data processing (e.g., user account verification, instant messaging, and social networking services), includes, but is not limited to:
   request handling module for handling and responding to various requests sent from client devices, including requests for profiling entities etc.;
   message processing module 228 that processes short unstructured electronic messages received from the client devices 104 with location information and associates the messages with venue entries stored in the server database 114 for profiling entities; this module also profiles venues based on content of the short unstructured electronic messages;
   clustering module to cluster the messages and the venues stored in the server database 114;
   data manipulation module 232 that builds and updates the records in the server database 114.
   sentiment analyzer 222 that analyzes short unstructured electronic messages and the sentiment of each message was computed using the sentiment analyzer 222 trained on messages.
one or more server database of venues 114 storing data for profiling entities, including but not limited to:
   geographic database 242 storing venue information for entities, wherein the geographic database 242 includes for a respective venue a venue name, a geographic location and one or more venue characteristics; the venue characteristics can be obtained by the server 108 from external service 122 according to some implementations;
   message database 244 storing messages received from the client devices 104; and
   cluster database 246 storing the clusters generated based on the geographic database 242 and the message database 244 and the profiling data computed for each cluster.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, memory 206, optionally, stores a subset of the modules and data structures identified above. Furthermore, memory 206, optionally, stores additional modules and data structures not described above.

FIG. 2B is a block diagram illustrating the geographic database 242, the message database 244, and the cluster database 246 in accordance with some implementations. In some implementations, the geographic database 242 stores venue information for entities. The geographic database 242 includes for a respective venue a venue name 254, a geographic location 252, and one or more venue characteristics, such as the number of check-ins 256 to the respective venue, the number of unique visitors 258 to the respective venue, and a core venue indicator 260 indicating whether the respective venue is a core venue in a cluster for social media-based profiling of entity location. Some of the information in the geographic database is based on venue information provided by an external service, such as Foursquare, which provides for a particular venue the venue name 254, geographic location 252 and one or more of a number of check-ins 256 for that location and a number of unique visitors 258 for that local. Other information in the geographic database 242 is generated by methods described herein, such as the core venue indicator 260.

During entity profiling, the geographic database 242 is associated with records in the message database 244 by matching. For example, a record stored in the message database 244 represents a short unstructured electronic message and in some implementations includes an associated a geographic location 262 and a message content 264. In some implementations, after obtaining the short unstructured electronic message, the message processing module 228 further identifies a venue name 266 and a characteristic 268 from the message content 264. In some implementations, the characteristic 268 can be computed after performing a preliminary operation of clustering. The message processing module 228 then access the geographic database 242 to determine whether the geographic database 242 includes a candidate venue that has a venue name 254 that is substantially similar to the venue name 266 and a venue geographic location 252 that is substantially similar to the associated geographic location 262. When the candidate venue exists in the geographic database 242, the message processing module 266 associates the short unstructured electronic message with a venue record associated with the candidate venue.

In some implementations, the venue record is stored in the cluster database 246 and when the venue record is associated with more than a threshold number of short unstructured electronic messages, the data manipulation module 239 updates the venue record stored in the cluster database 246 based on the characteristics 268 of the associated short unstructured electronic messages. In some implementations, the characteristics 268 include a sentiment score 272 and a group size 274. Some short unstructured electronic messages may contain facial images. As a result, these messages records include facial image 270 information.

As shown in FIG. 2B, in some implementations, the clustering module 232 clusters venue records stored in the geographic database 242 and the geo-tagged messages stored in the message database 244 into a plurality of clusters 280-1 . . . 280-2. Each cluster 280 includes a plurality of venue records 282-1 . . . 282-2. The venue record 282 is associated with the venue record stored in the geographic database 242, which is further associated with the messages stored in the message database 244. During clustering, one of the venue records is identified as a core venue for each of the clusters 280 based on characteristics, such as the venue with the most number of check-ins 256 etc. Further during clustering, the data manipulation module 239 updates the core venue identifier 260 of the corresponding venue record and a core venue tag 272 of associated records in the message database 244.

In some implementations, once clustering is complete, the data manipulation module 239 computes characteristics such as an overall sentiment 284 and an average group size 286 for the venue record 282. The information stored in the overall sentiment 284 and the average group size 286 may then be used to show the results of profiling entities, such as how sentiment differs across stores in the same chain, how some chains have more positive sentiment than other chains, and/or how the size of a social group can vary. Note that the data structures described with reference to this and other figures are representative of some implementations. Other implementations may arrange the described data structure elements differently, and may employ subsets or supersets of the described elements and associated information.

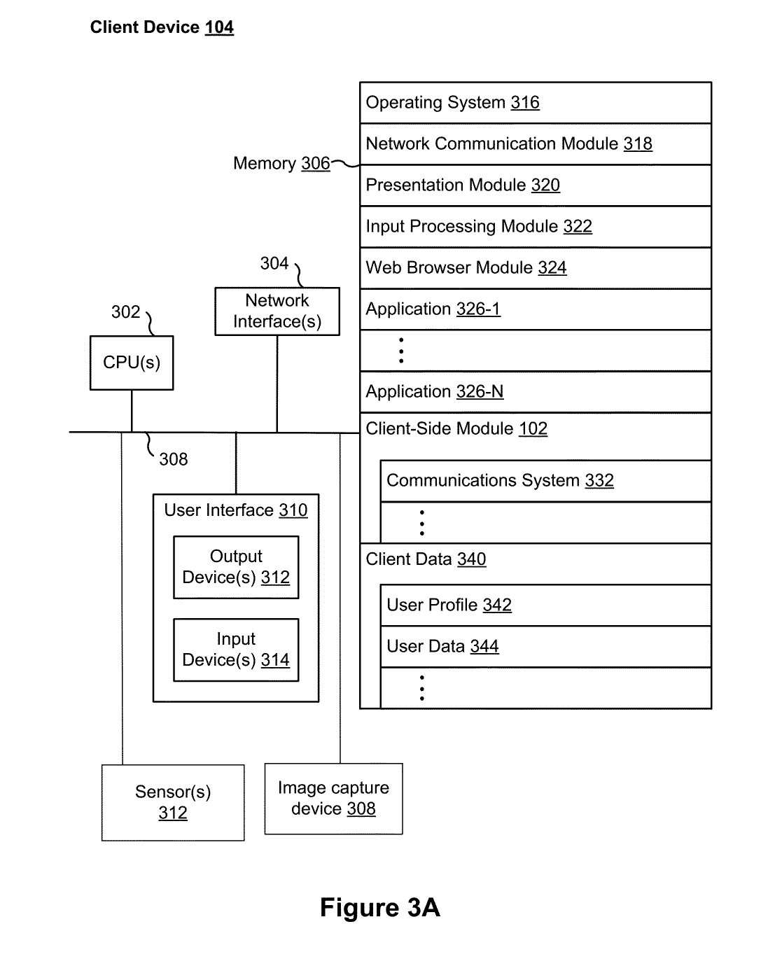

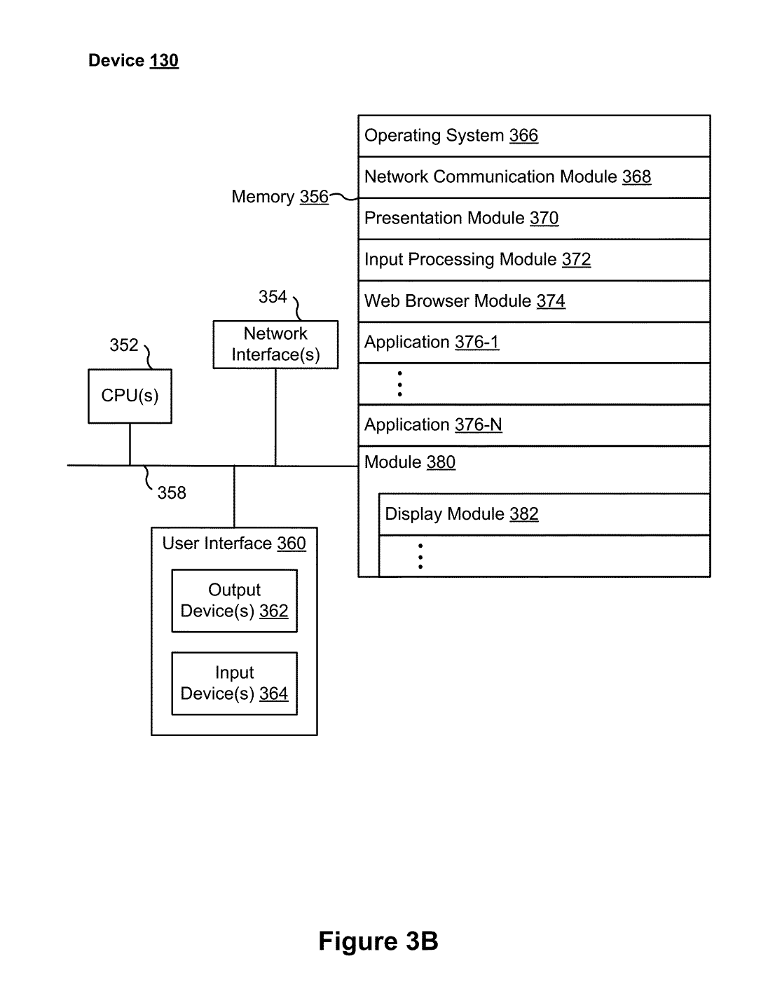

FIG. 3A is a block diagram illustrating a representative client device 104 in accordance with some implementations. A client device 104, typically, includes one or more processing units (CPUs) 302, one or more network interfaces 304, memory 306, a image capture device 308, optionally one or more sensors 312, and one or more communication buses 308 for interconnecting these components (sometimes called a chipset). Client device 104 also includes a user interface 310. The user interface 310 includes one or more output devices 312 that enable presentation of media content, including one or more speakers and/or one or more visual displays. The user interface 310 also includes one or more input devices 314, including user interface components that facilitate user input such as a keyboard, a mouse, a voice-command input unit or microphone, a touch screen display, a touch-sensitive input pad, a camera (e.g., for scanning an encoded image), a gesture capturing camera, or other input buttons or controls. Furthermore, some client devices 104 use a microphone and voice recognition or a camera and gesture recognition to supplement or replace the keyboard.

Memory 306 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 306, optionally, includes one or more storage devices remotely located from one or more processing units 302. Memory 306, or alternatively the non-volatile memory within memory 306, includes a non-transitory computer readable storage medium. In some implementations, memory 306, or the non-transitory computer readable storage medium of memory 306, stores the following programs, modules, and data structures, or a subset or superset thereof:
operating system 316 including procedures for handling various basic system services and for performing hardware dependent tasks;
network communication module 318 for connecting client device 104 to other computing devices (e.g., server system 108 and external service(s) 122) connected to one or more networks 110 via one or more network interfaces 304 (wired or wireless);
presentation module 320 for enabling presentation of information (e.g., a user interface for a social networking platform, widget, webpage, game, and/or application, audio and/or video content, text, and/or displaying an encoded image for scanning) at client device 104 via one or more output devices 312 (e.g., displays, speakers, etc.) associated with user interface 310;
input processing module 322 for detecting one or more user inputs or interactions from one of the one or more input devices 314 and interpreting the detected input or interaction (e.g., processing the encoded image scanned by the camera of the client device);
one or more applications 326-1-326-N for execution by client device 104 (e.g., camera module, sensor module, games, application marketplaces, payment platforms, social network platforms, and/or other applications involving various user operations);
client-side module 102, which provides client-side data processing and functionalities, including but not limited to:
   communications system 332 for generating and sending requests for entity profiling and sending messages, including short messaging and/or instant message applications; and
client data 340 storing data of a user associated with the client device, including, but is not limited to:
   user profile data 342 storing one or more user accounts associated with a user of client device 104, the user account data including one or more user accounts, login credentials for each user account, payment data (e.g., linked credit card information, app credit or gift card balance, billing address, shipping address, etc.) associated with each user account, custom parameters (e.g., age, location, hobbies, etc.) for each user account, social network contacts of each user account; and
   user data 288 storing usage data of each user account on client device 104.

In some implementations, the image capture device 308 is any image capture device with connectivity to the networks 110 and, optionally, one or more additional sensors 312 (e.g., Global Positioning System (GPS) receiver, accelerometer, gyroscope, magnetometer, etc.) that enable the position and/or orientation and field of view of the camera device 308 to be determined. For example, the image capture device 308 may be an external camera or a camera built into a tablet device or smart phone from which the user 124 of the client device 104 also sends messages. As a result, the camera device 308 can provide audio and video and other environmental information for meetings, presentations, tours, and musical or theater performances, all of which can be experienced by a remote user. The camera module captures images (e.g., video) using the image capture device 308, encodes the captured images into image data, and transmits the image data to the server system 108. In some implementations, the camera device 308 includes a location device (e.g., a GPS receiver) for determining a geographical location of the camera device 308.

In some implementations, the sensors 312 include one or more of: a GPS receiver, an accelerometer, a gyroscope, and a magnetometer. The sensor module obtains readings from sensors 312, processes the readings into sensor data, and transmits the sensor data to the server system 108. In addition to obtaining geolocation information from GPS, the geolocation information can come from known locations of transmitters on the client device 104, or transmitter triangulation, among others. In some implementations, a GPS sensor or sensors 312 can provide location information used to geo-tag short messages that are processed by the server 108.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various implementations. In some implementations, memory 306, optionally, stores a subset of the modules and data structures identified above. Furthermore, memory 306, optionally, stores additional modules and data structures not described above.

In some implementations, at least some of the functions of server system 108 are performed by client device 104, and the corresponding sub-modules of these functions may be located within client device 104 rather than server system 108. In some implementations, at least some of the functions of client device 104 are performed by server system 108, and the corresponding sub-modules of these functions may be located within server system 108 rather than client device 104. Client device 104 and server system 108 shown in FIGS. 2A and 3A, respectively, are merely illustrative, and different configurations of the modules for implementing the functions described herein are possible in various embodiments.

FIG. 3B is a block diagram illustrating a representative end user device 130 in accordance with some implementations. The end user device 130, typically, includes one or more processing units (CPUs) 352, one or more network interfaces 354, memory 356, and one or more communication buses 358 for interconnecting these components (sometimes called a chipset). The end user device 130 also includes a user interface 360. User interface 360 includes one or more output devices 362 that enable presentation of media content, including one or more speakers and/or one or more visual displays. User interface 360 also includes one or more input devices 364, including user interface components that facilitate user input such as a keyboard, a mouse, a voice-command input unit or microphone, a touch screen display, a touch-sensitive input pad, a camera (e.g., for scanning an encoded image), a gesture capturing camera, or other input buttons or controls. Furthermore, some client devices 104 use a microphone and voice recognition or a camera and gesture recognition to supplement or replace the keyboard.

Memory 356 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 356, optionally, includes one or more storage devices remotely located from one or more processing units 352. Memory 356, or alternatively the non-volatile memory within memory 356, includes a non-transitory computer readable storage medium. In some implementations, memory 356, or the non-transitory computer readable storage medium of memory 356, stores the following programs, modules, and data structures, or a subset or superset thereof:
operating system 366 including procedures for handling various basic system services and for performing hardware dependent tasks;
network communication module 368 for connecting the end user device 130 to other computing devices (e.g., server system 108 and external service(s) 122) connected to one or more networks 110 via one or more network interfaces 354 (wired or wireless);
presentation module 370 for enabling presentation of information (e.g., a user interface for a social networking platform, widget, webpage, game, and/or application, audio and/or video content, text, and/or displaying an encoded image for scanning) at client device 104 via one or more output devices 362 (e.g., displays, speakers, etc.) associated with user interface 360;
input processing module 372 for detecting one or more user inputs or interactions from one of the one or more input devices 364 and interpreting the detected input or interaction (e.g., processing the encoded image scanned by the camera of the client device);
one or more applications 376-1-376-N for execution by client device 104 (e.g., camera module, sensor module, games, application marketplaces, payment platforms, social network platforms, and/or other applications involving various user operations); and
module 380, which provides data processing and functionalities, including but not limited to:
   display module 382 for displaying entity profiling results.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various implementations. In some implementations, the memory 356, optionally, stores a subset of the modules and data structures identified above. Furthermore, the memory 356, optionally, stores additional modules and data structures not described above.

In some implementations, at least some of the functions of server system 108 are performed by device 130, and the corresponding sub-modules of these functions may be located within device 130 rather than the server system 108. In some implementations, at least some of the functions of device 130 are performed by server system 108, and the corresponding sub-modules of these functions may be located within server system 108 rather than device 130. Device 130 and server system 108 shown in FIGS. 2A and 3B, respectively, are merely illustrative, and different configurations of the modules for implementing the functions described herein are possible in various embodiments.

In some implementations, to profile entities, venues for entities are associated with public posts expressing opinions on social media-based platforms. Venues for entities can be collected from some external services 122, such as Foursquare or Yelp. In one example, a Foursquare venue is tagged with the name of a place/venue and a geo-coordinate. Although Foursquare users may make comments when they check-in to a venue, they are not public on the Foursquare site. To gather public postings, some external services 122, such as Twitter, can be used to collect short unstructured electronic messages expressing opinions.

Foursquare venues are crowd-sourced locations that users identify when they check-in to a place. Foursquare recommends checking into places that the user is at, rather than what the user is walking by. It also discourages fake check-ins, but it should be noted that some users are creative in naming locations, especially their homes. For example, a collection area is defined to be inside latitude [37.10, 38.15] and longitude between [−122.6, −121.6], which covers most of the San Francisco Bay Area, including San Francisco and San Jose. One dataset collection for venues in the collection area shows there are six homes that include “The Chamber of Secrets” in the name. In some implementations, Foursquare is queried using its venue search API3 for venues near geo-coordinates of areas where venues are to be profiled based on geo-tagged short messages. In one example described below, the geo-coordinates are of San Francisco Bay Area tweets. In this example, the query rate was kept below Foursquare's rate limit. And the results were cached to reduce the number of queries. When the maximum number of results was returned, the query was refined to a smaller area to try retrieving all of the closest locations. The meta-data extracted for each venue includes, but not limited to:
latitude, longitude
venue name
number of check-ins
number of unique visitors

Tweets are public and provide a sample of user opinions from a wide variety of sources and social media platforms. In addition to posting tweets directly from a Twitter App, e.g., Twitter for iPhone or Twitter for Android, other social media platforms, such as Foursquare, often allow users to publicly post through Twitter as well as on the source itself. Other than using Twitter as the external service 122 for obtaining short unstructured electronic messages, more than 1100 other sources can be used to obtain geo-tagged short unstructured electronic messages. Such popular sources, other than Twitter apps, include Instagram and Foursquare, among others.

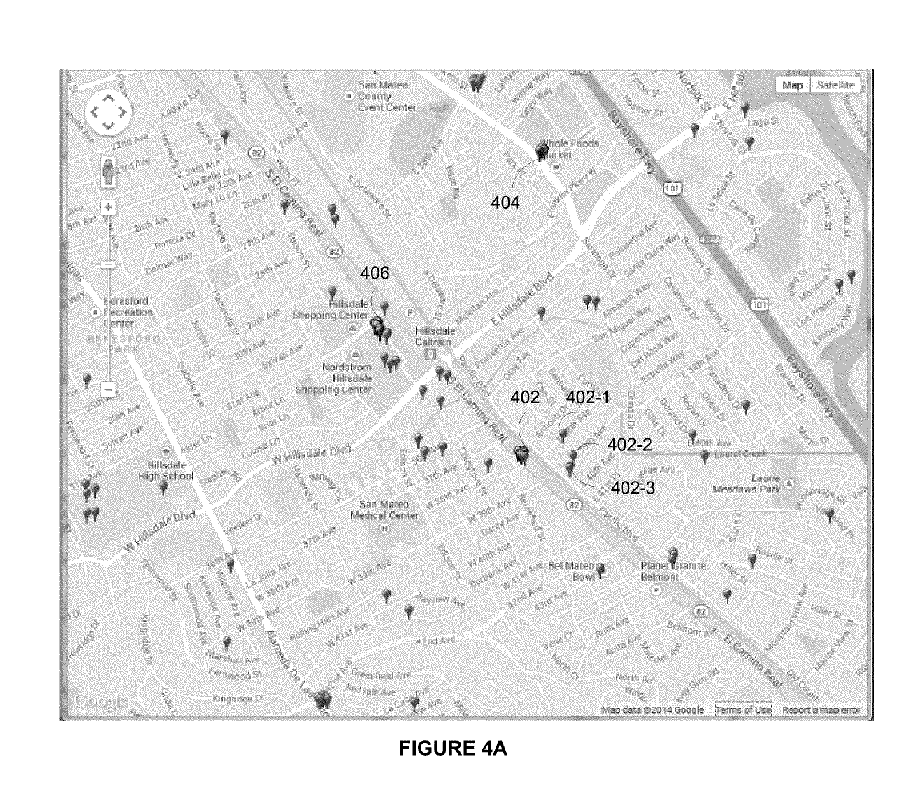

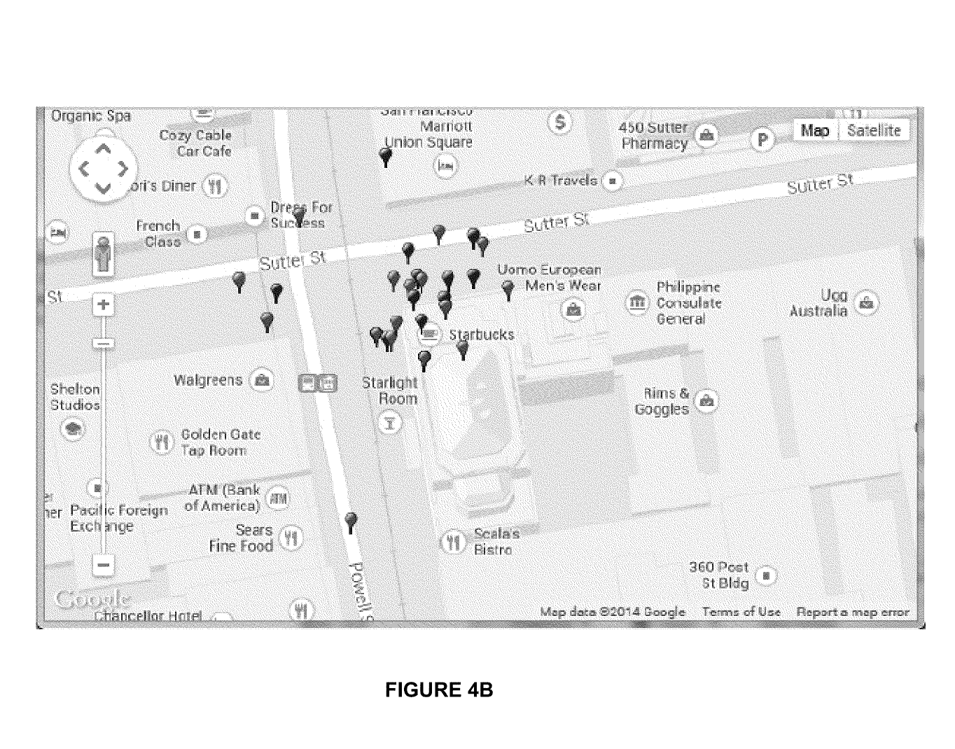

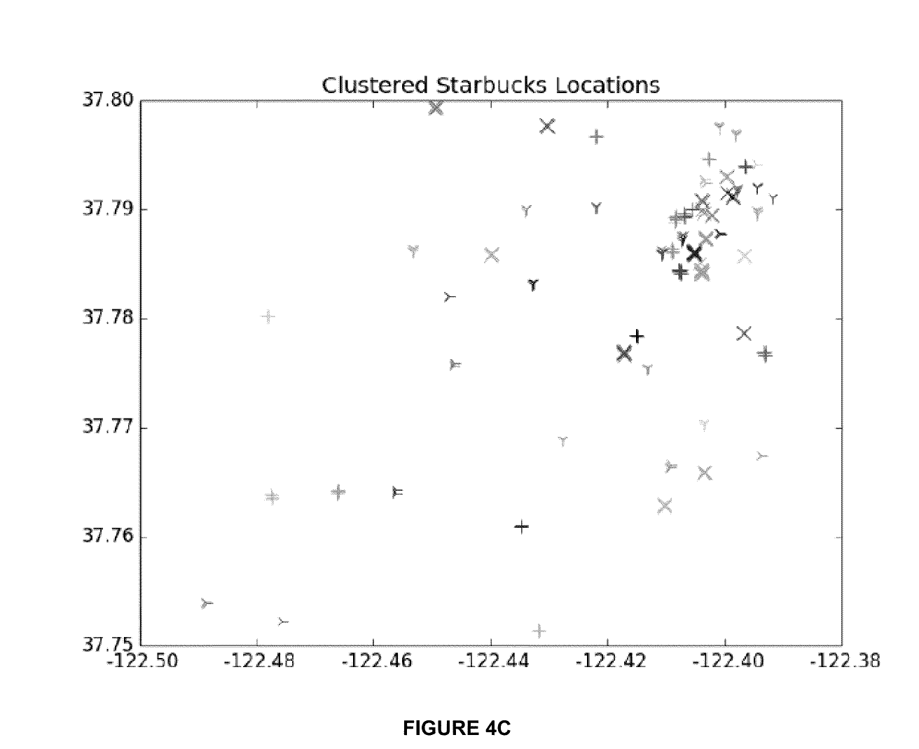

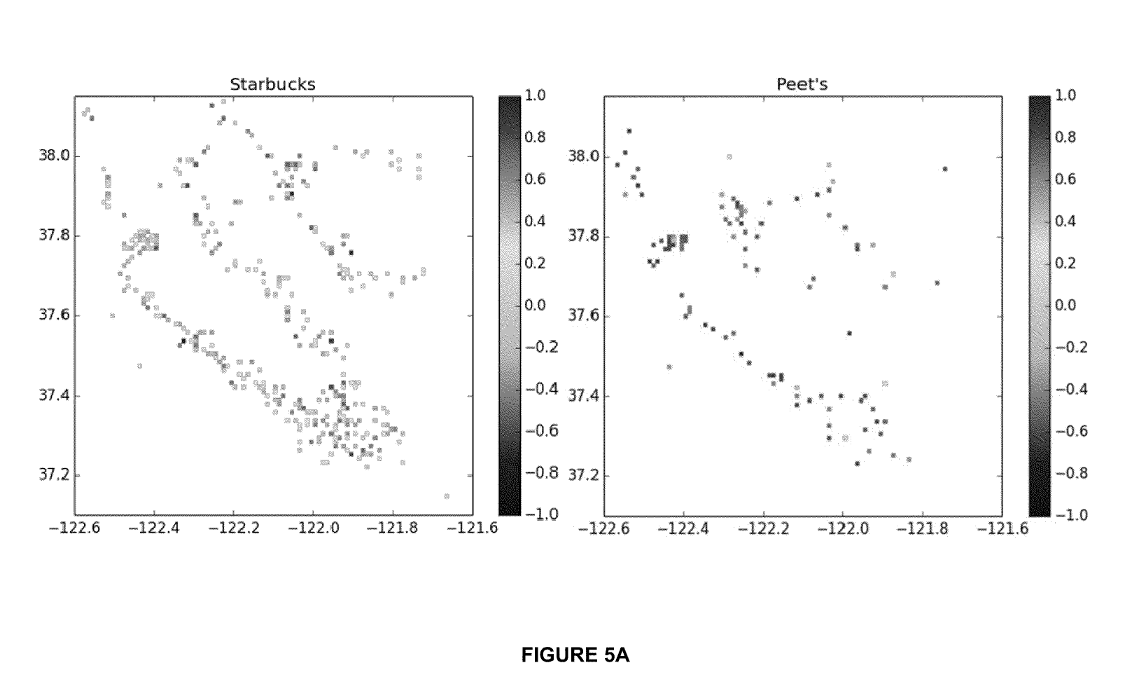

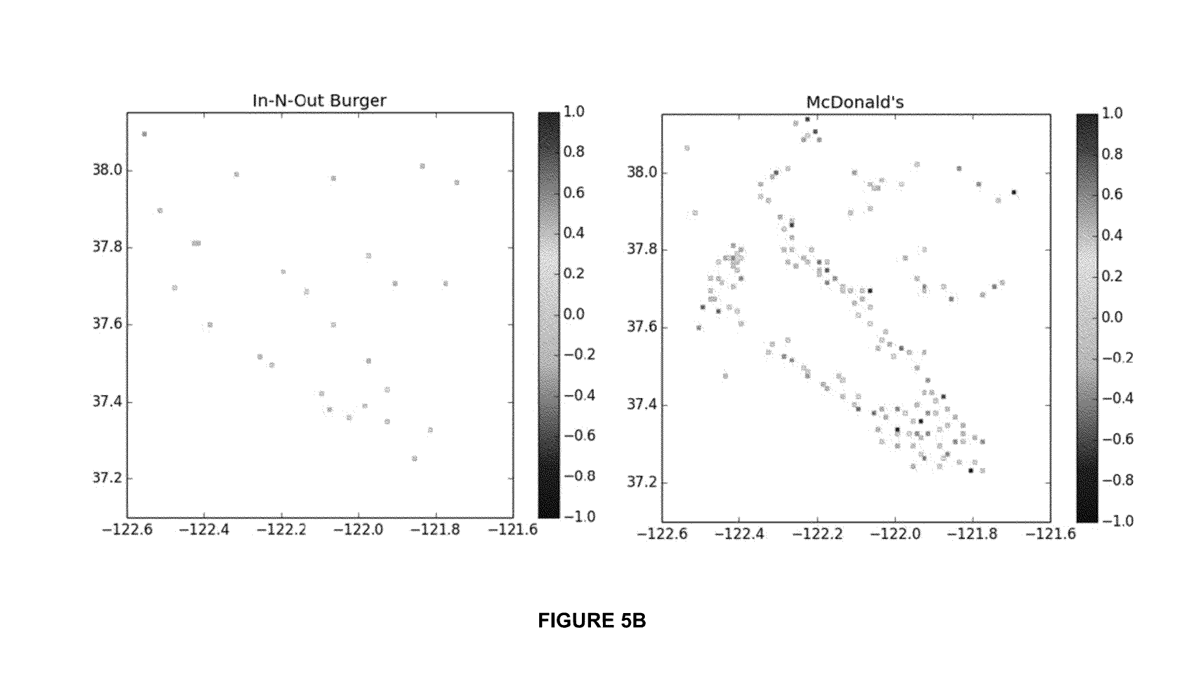

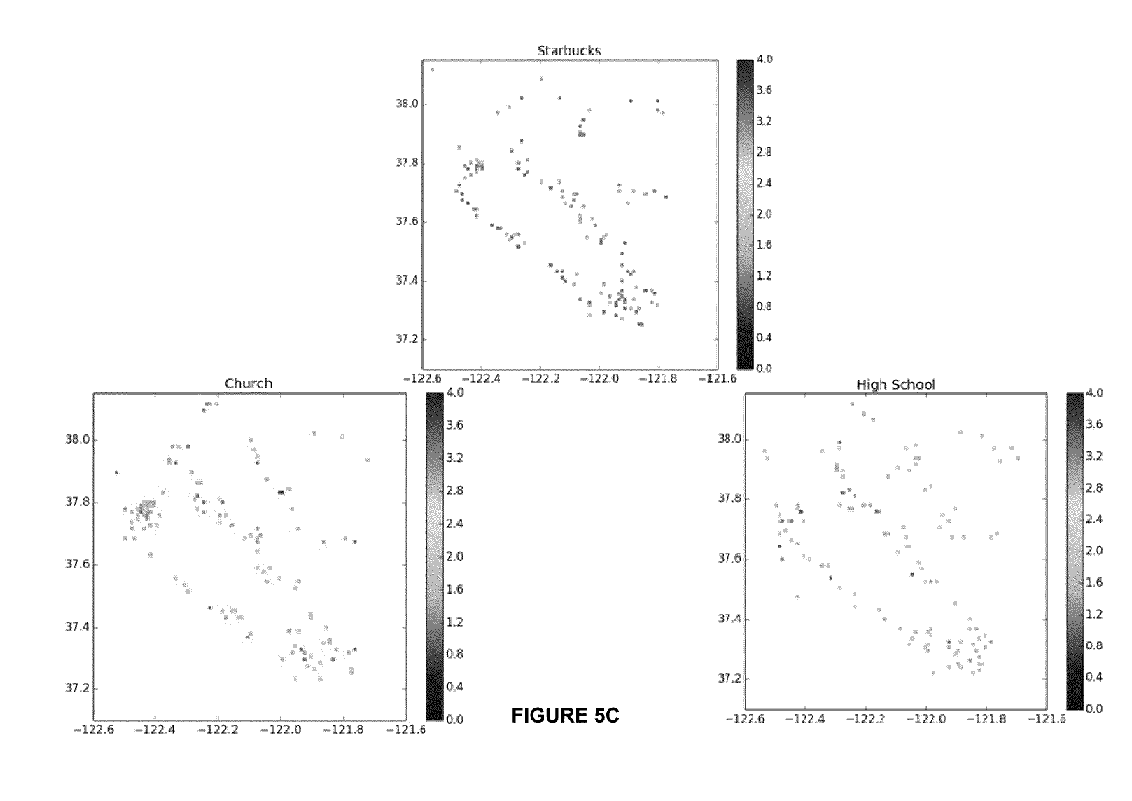

In some implementations, tweets are collected using the Twitter Streaming API2. In one example described below, a geo-query is specified for tweets inside the collection coordinates of latitude [37.10, 38.15] and longitude [−122.6, −121.6] and collected 16,040,427 geo-tagged tweets during 10-month period from Jun. 4, 2013 to Apr. 7, 2014 for generating the results shown in FIGS. 4A-5C. This corresponds to tweets originating from senders in the San Francisco Bay Area. In some implementations, some short unstructured electronic messages have one or more links to photos. From the metadata associated with a short unstructured electronic message, links to photos, such as Instagram photos mentioned in the tweets, can be identified and downloaded. In one example, a total of 601,164 photos were downloaded for use in entity location profiling and generating profiling results as shown in FIG. 5C.

In some implementations, once the venue data and the short unstructured electronic messages are collected, the linkage among the venue data stored in the geographic database 242, the short unstructured electronic messages stored in the messages database 244, and the clusters stored in the cluster database 246 can be established. To match geo-tagged short unstructured electronic messages to venues for social media-based profiling of entity location, several factors need to be considered.

First, short unstructured electronic messages from other external services 122, such as tweets, need to be associated with a venue to identify tweets that are relevant to a store/business location. Although the geo-coordinates of a tweet when Foursquare is the source can be directly mapped to a venue (in one trial of a described implementation), Foursquare was the source of 492,529 tweets), short unstructured electronic messages from other external services 122 as sources may instead reflect the geo-coordinates of the user's current location.

FIG. 4A shows the location of entity venues (blue) for three locations 402, 404, and 406, and the location of all short unstructured electronic messages where the entity name is mentioned (red). As shown in FIG. 1, many of the short unstructured electronic messages are not near an entity venue, such as the messages located at 402-1, 402-2, and 402-3 are across a major street from the entity venue 402. It is unclear from FIG. 1 which location, if any, is being referred to for many of the messages that mention the entity name.

In order to identify the tweets for the association, tweets are filtered to keep those where a venue name is mentioned. However, as shown in FIG. 4A, it is unclear which Starbucks location, if any, is being referred to for many of the tweets that mention Starbucks. A user may refer to a place in their tweet text without actually being there, as shown by the many red markers in FIG. 4A that are not near a blue marker. If there are multiple venues with the same name, as in FIG. 4A, it can be difficult to determine the actual location, if any, to which the user was referring. Thus, the associated tweets also need to be within a predetermined distance from the venue. In some implementations, the Great Circle Distance was used for computing distances, and an example predetermined distance requires that the tweets to be within 0.0008 degrees, or about 290 ft, from the venue.

Second, venues with different geo-coordinates that actually represent the same venue need to be identified. Some geographic databases, such as Foursquare, each place, e.g., a specific Starbucks store, may have multiple check-in locations. This is because the venues are crowd-sourced in Foursquare. People may create a new venue for different reasons. For example, the store may be large and cover a large area or they may check in when they are near, but not in, the store.

FIG. 4B is an example of a Starbucks location with multiple associated Foursquare venues. FIG. 4B shows multiple entity venues (blue) associated with one entity location (e.g., Starbucks) and short unstructured electronic messages associated with the entity venues (red). As shown in FIG. 4B, some of the venues and messages are closer to other entities and venues than they are to the actual entity location (e.g., Starbucks). These venues are identified as representing the same venue.

To match geo-tagged short unstructured electronic messages to venues, pseudocode for a multi-step process as shown below in lines 1-15 is performed in some implementations.

### Profiling Process 1 Grouping Venue and Tweet Locations

Input: u: user-specified venue, D: specified maximum geo-distance
between a venue and tweet, V : a set of geo-tagged venue locations
containing u, T: a set of geo-tagged tweets Output: venueTweetGroups:
clusters of venues and tweets associated with each store at a specific
location

| | |
|---|---|
| 1: | result ← { } |
| 2: | venueTweets ← { } |
| 3: | candTweets ← { } |
| 4: | for each tweet t in T do |

| | |
|---|---|
| 5: | if u ∈ t then |

| | |
|---|---|
| 6: | venueTweets ← t |

| | |
|---|---|
| 7: | end if |

| | |
|---|---|
| 8: | end for |
| 9: | for each venue v in V do |

| | |
|---|---|
| 10: | for each tweet t in venueTweets do |

| | |
|---|---|
| 11: | if ∥geo(v) − geo(t)∥ < D then |

| | |
|---|---|
| 12: | candTweets ← t |

| | |
|---|---|
| 13: | end if |

| | |
|---|---|
| 14: | end for |

| 15: | end for |
|---|---|
| 16: | clusters, outliers ← DBScan(candTweets U |
| | V, minNeighbor-Size=5 ) |
| 17: | venueTweetGroups ← clusters − outliers |

In this process, the variable u represents a user-specified venue name to be profiled (e.g., “Starbucks”), the variable D: represents a specified maximum geo-distance between a venue and a short tweet, the variable V represents a set of geo-tagged venue locations (e.g., venues provided by Foursquare or another source of tagged venue information, such as Yelp) containing the user specified venue name u, and the variable T represents a set of geo-tagged tweets to be processed as part of profiling different venues. The resulting output of this profiling process is the variable: venueTweetGroups, which includes clusters of venues and tweets associated with each store or other entity (having the user-specified venue name) at a specific location.

After performing the above steps in lines 1-15, for a specified Foursquare venue name, tweets that mention the user-specified venue, and optionally, venue nicknames, are identified. These tweets are then filtered to keep those that are within a predetermined distance D, such as (0.0008 degrees, or about 290 ft) from a Foursquare venue with the specified name.

A store at a given location, e.g., a specific Starbucks store, may have multiple check-in locations because Foursquare venues are crowd-sourced. People may create a new venue for different reasons. For example, the store may cover a large area or a user may check in when they are near, but not in, the store. They may also make fake Foursquare venues.

To combine multiple venues associated with a single store and also to try and filter out fake venues, clustering is performed to group geo-coordinates. A minimum number of check-ins and unique visitors in each cluster is needed, based on the assumption that there will be few check-ins and unique users at a fake venue. Specifically, as shown in step 16 above, in some implementations, DBSCAN (from the scikit clustering library) is applied over all venues tagged with the location names and all tweets containing the location name.

In some implementations, the clustering is performed over both venues and tweets to take advantage of the fact that tweets, unlike venues, are not constrained to a few pre-specified locations, as shown in FIG. 4B. Thus, the set of unique locations that include tweets may be denser, which should make the clustering by DBSCAN, which performs density-based clustering, more robust. In some implementations, for DBSCAN, the maximum distance between two samples is set to be 0.0008 degrees, or about 290 ft. A minimum of five samples in the neighborhood of a geo-coordinate was required, or else the samples were regarded as outliers. The outlier samples may be due to fake Foursquare venues, as well as non-popular locations or users mentioning a venue when they are somewhere else. As shown in step 17 of the above algorithm, the outlier samples are filtered out from the clusters so that the entity profiling excludes the outliers. Though density-based clustering, such as DBScan is shown in the above example algorithm, it should be noted that other clustering mechanism can also be used in place of density-based clustering. A visual representation of the clustering is shown in FIG. 4C.

FIG. 4C is an example result of clustering venues and short unstructured electronic messages. The example plot shows Starbucks locations in the city of San Francisco. Each cluster is a unique color and shape combination. Wider or fuzzy marks indicate that multiple nearby venues and tweets were grouped into one cluster.

In some implementations, the short unstructured electronic messages associated with a cluster are tagged with the “core” venue and its location, where the core venue is defined to be the venue in the cluster with the most check-ins. Outlier samples are not tagged and therefore are not used in profiling.

In some implementations, an entity location is characterized with two types of attributes to illustrate the profiling of store locations: average sentiment expressed by customers and the size of the social groups as estimated by the photos people take at a location. Other attributes may also be identified from the message contents of short unstructured electronic messages associated with venue records and used to characterize entities and profile entities.

There have been many works on general sentiment estimation, and a smaller number focused on estimating the sentiment of tweets. Tweet sentiment estimation methods based on machine learning have been observed to perform slightly better than lexicon-based methods. To estimate the sentiment of tweets at a location, in some implementations, a logistic-regression based sentiment analyzer 222 trained on Twitter tweets is implemented.

In some implementations, the sentiment of each tweet is computed using a sentiment analyzer 222 trained on tweets. There are also several open source options available for identifying sentiment from short message content, including Sentiment 140 and SentiStrength. In some implementations, only subjective tweets are used for social media-based profiling of entity location, i.e., objective tweets are ignored. The subjective tweets are assigned a score ranging from −1.0 to 1.0 corresponding to very negative to very positive sentiment. Any such existing methods, or new methods for estimating sentiment from content of short messages or other written information, can be employed in various implementations to estimate sentiment associated with short messages or other information sources that are processed to profile venues based on visitor sentiment. In addition, venues can be profiled based on a wide range of characteristics, sentiment and group size per visit being only representative examples of such characteristics.

In some implementations, accurate identification of non-opinionated tweets is important because many tweets do not express sentiment. For example, the default for checking in on Foursquare is “I'm at <placename> (<place location>) <URL>”. Another common use of Twitter is for people to announce their status: for example “using Starbucks wifi cause I can”, or “Starbucks with chriiisssss”. Subjectivity classification of each tweet was first performed by determining whether the tweet text contained subjective terms from the Multi-Perspective Question Answer (MPQA) subjectivity lexicon.

In some implementations, it was observed that topic-dependent Twitter sentiment models improve performance for only some topics. Since the tweets may cover a variety of topics, in some implementations, a topic-independent model is created.

In some implementations, the polarity of the tweets that were deemed subjective (as opposed to objective) was computed using the distant learning approach. In some implementations, the training data from the Sentiment 140 tweet corpus can be used for distant learning. The sentiment analyzer 222 outputs two values: 1) whether the tweet is subjective or objective and 2) a score ranging from −1.0 to 1.0 corresponding to very negative to very positive sentiment.

To visualize the profiling results, heatmaps are created of a profile attribute at different locations of the same venue, e.g., Starbucks at different locations. The collection area inside the collection coordinates of latitude [37.10, 38.15] and longitude [−122.6, −121.6] was used in generating the heatmaps in FIGS. 5A-5B. This area covers most of the San Francisco Bay Area (SFBA), including San Francisco (middle left) and San Jose (bottom right). The longitude and latitude values were each quantized into 100 bins, for a total of 10,000 cells. White areas in a heatmap indicate that a store was not present.

To create a sentiment heatmap, for each set of short unstructured electronic messages that were clustered to the same “core” venue, the short unstructured electronic messages were filtered to keep those where a nonzero sentiment was expressed. Very negative to very positive sentiment was mapped over the color spectrum from blue to red, respectively. The average sentiment score for the tweets associated with all core values in a cell was computed and used as the value of the heat map. In some implementations, heatmaps, examples of which are shown in FIGS. 5A and 5B, are generated from venue profile information download from the server 108 to an end user device 130 and displayed and/or interacted with via a user interface 360 of the device 130. Such an end user device 130 might be employed by a employee at a company or business being profiled, by a marketing consultant, or by an advertising agency, for example, to gain a better and timelier understanding of how a company is viewed by customers or other visitors based on any number of characteristics of that venue that are described in short messages sent by casual visitor communications about the venue.

FIG. 5A illustrates that in the example scenario described above, different Starbucks locations exhibit a variety of average sentiment values. While most of the locations are slightly positive (yellow), some are highly positive (red) and a smaller number are highly negative (dark blue). Peet's Coffee & Tea is a smaller competitor to Starbucks. Comparing the average sentiment for Starbucks locations and Peet's locations, FIG. 5A shows Peet's locations tend to have primarily positive sentiment, noticeably higher than Starbuck's on average. The more positive perception of Peet's is in agreement with the average Yelp scores for the first 20 results returned from queries for Starbucks and Peet's in San Francisco (on Jul. 10, 2014), with values of 3.6 and 4.0 (out of a best score of 5.0), respectively.

FIG. 5B illustrates the comparison between two fast food burger chains, In-N-Out Burger, which advertises its ingredients as being freshly made each day, with McDonald's. As shown in FIG. 5B that while In-N-Out Burger has mildly positive sentiment overall, the sentiment about McDonald's locations varies but is overall more negative. Also, there are several McDonald's locations that exhibit quite negative sentiment. Again, the more positive perception of In-N-Out is in agreement with average Yelp scores of 4.25 and 2.55 for the two In-N-Out stores in or near San Francisco and first 20 results from a query for Mc-Donald's stores in San Francisco, respectively.

This type of store location-based information can be used by management to identify stores with happy customers that are more likely to have good practices and to perhaps use this information to improve more poorly-rated stores.

FIG. 5C illustrates the size of social groups visiting different venues. Knowing the size of social groups who visit a venue or shop (singles, pairs, small, or large groups) can be helpful to commercial businesses for targeting their products and advertisements appropriately. The classification of people in photos into social groups has been used for travel recommendation. Following some conventional methods classified travel groups into solo, couple, family, and friends, social group size is defined based on the number of faces in a photo. In some implementations, tweeted photos were downloaded and faces detected using the OpenCV face detector, which detected faces in a total of 165,844 photos. When there was at least one face in a photo, the number of faces were quantized into one of four classes: single (1 face), pair (2 faces), small group (3-6 faces) and larger group (at least 7 faces), and mapped to a group size code of 1, 2, 3, or 4, respectively. These codes were used when computing average group size for the example heatmaps as shown in FIG. 5C.

The heatmaps in FIG. 5C visualize the detected social group sizes at Starbucks locations, at churches, and at high schools in the San Francisco Bay Area. FIG. 5C shows that the Starbucks heat map is skewed towards single faces. In contrast, the heat map for churches exhibits somewhat larger social groups on average, with some red and orange areas. And high schools tend to have even larger social groups. This observation is intuitive as people visit coffee shops more frequently alone than with friends or family, churches are gathering places that host social events, including weddings, and teens in school tend to photograph themselves with friends.

It should be noted that the system and method disclosed herein can be applied to other venue types, such as Points of Interest (e.g., aquarium, zoo, scenic lookout, stadiums) and public transportation stations (e.g., BART, Caltrain). It should also be noted that the system and method disclosed herein can be applied to other social media or other comments with geo-position tags where the geo-positioning can be any means, including for example, RFID and/or audio.

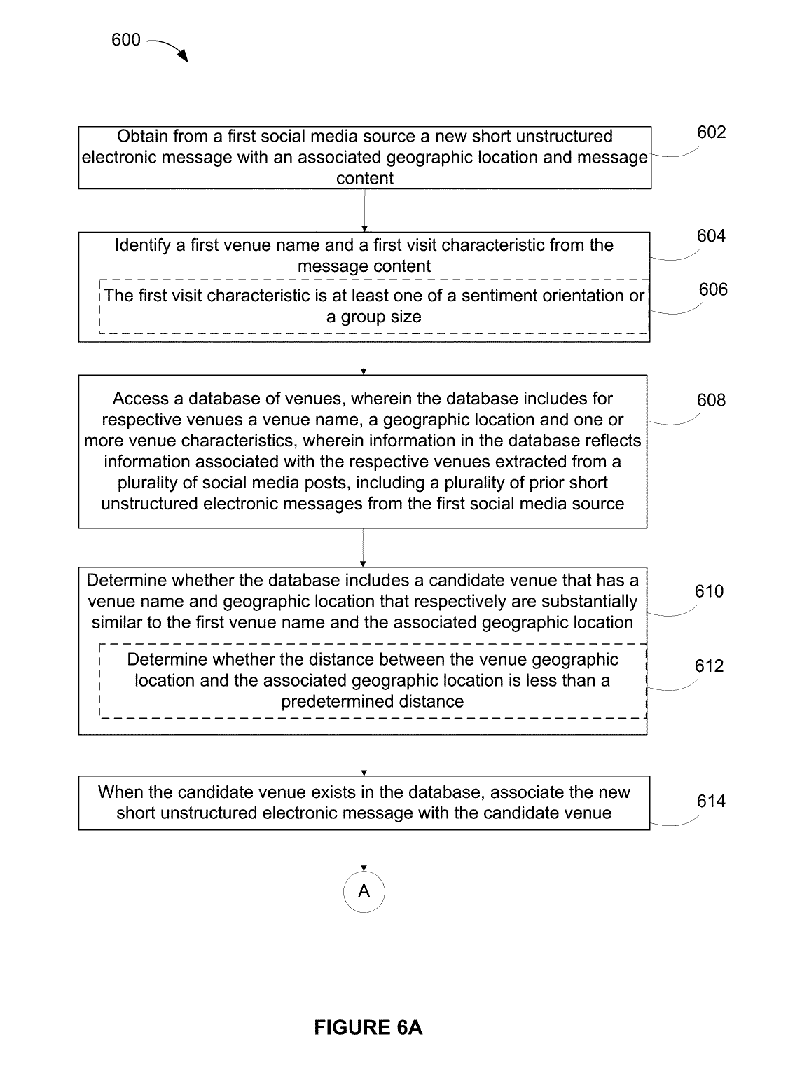

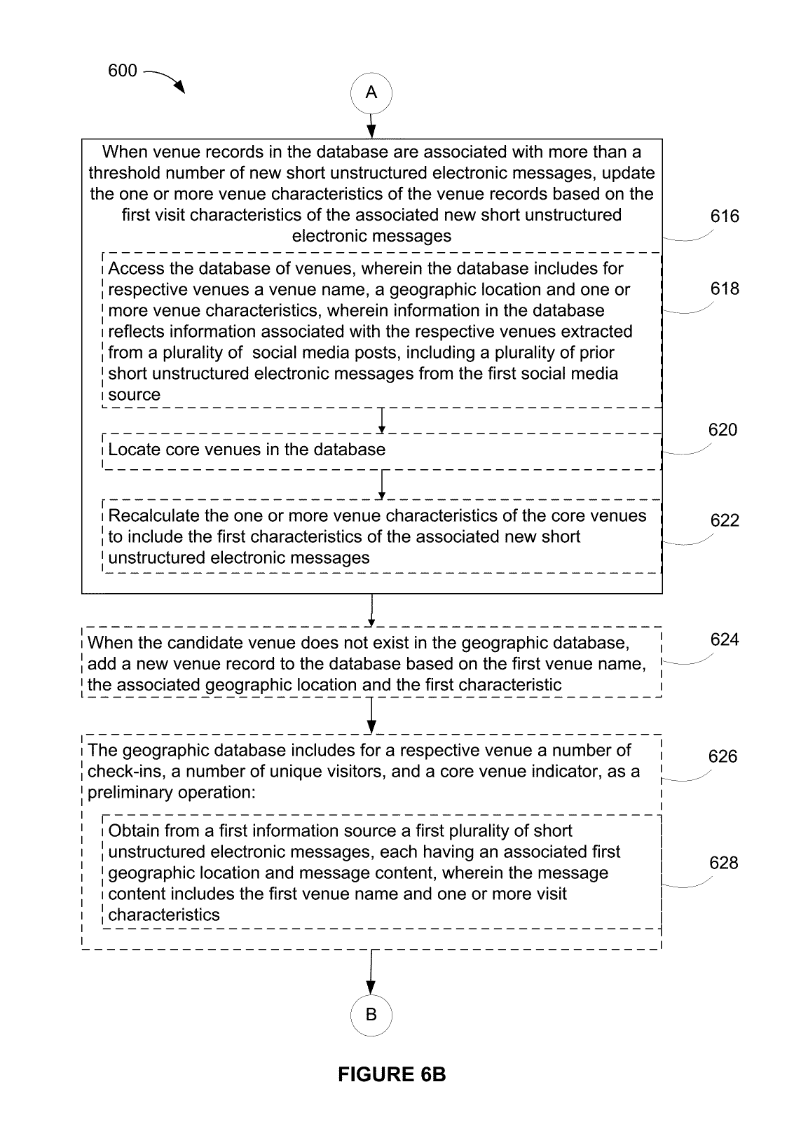

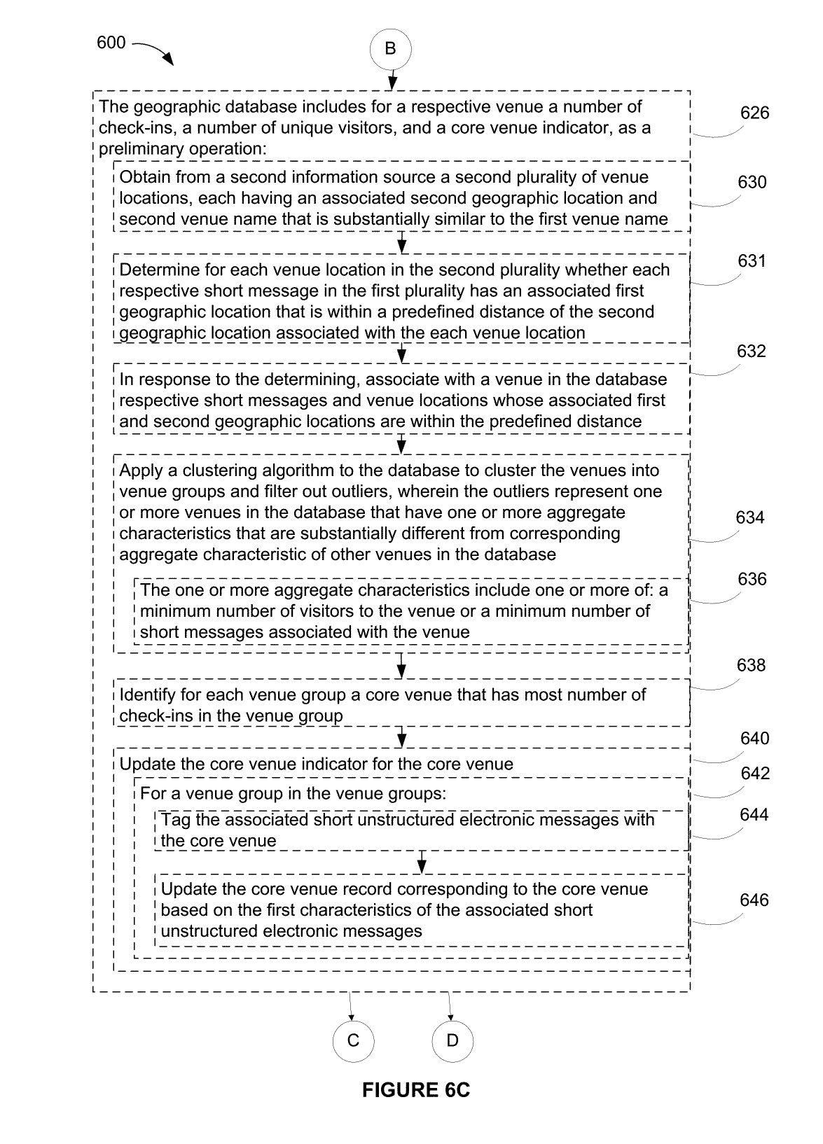

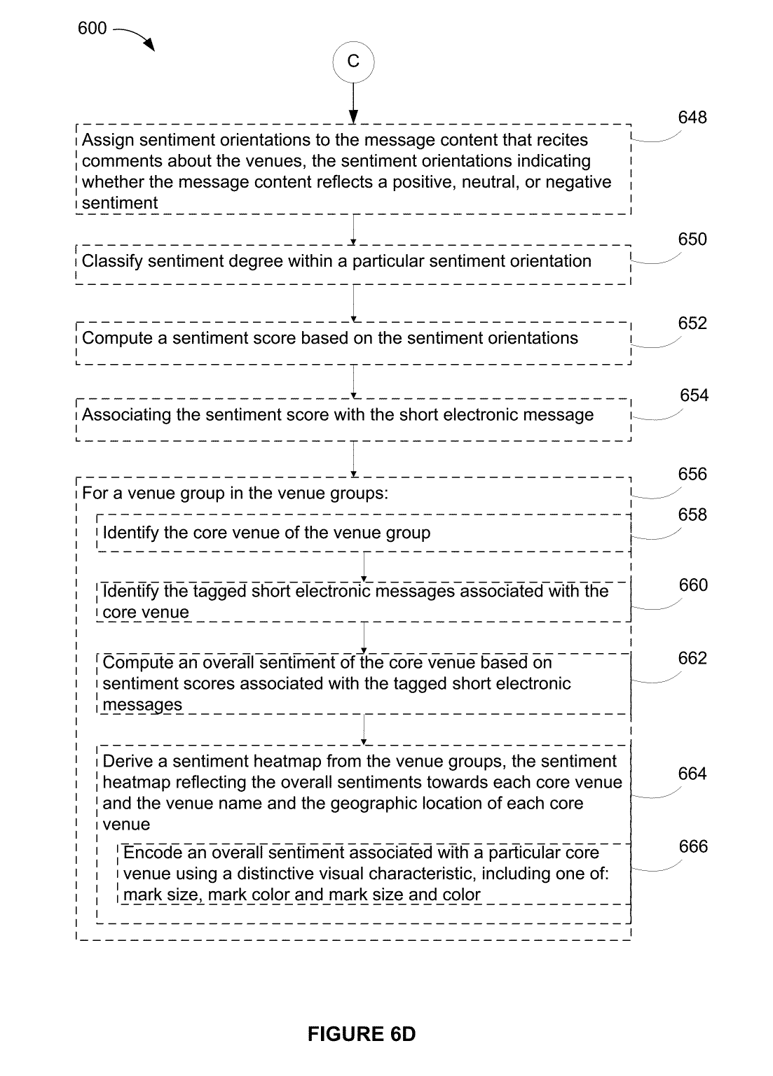

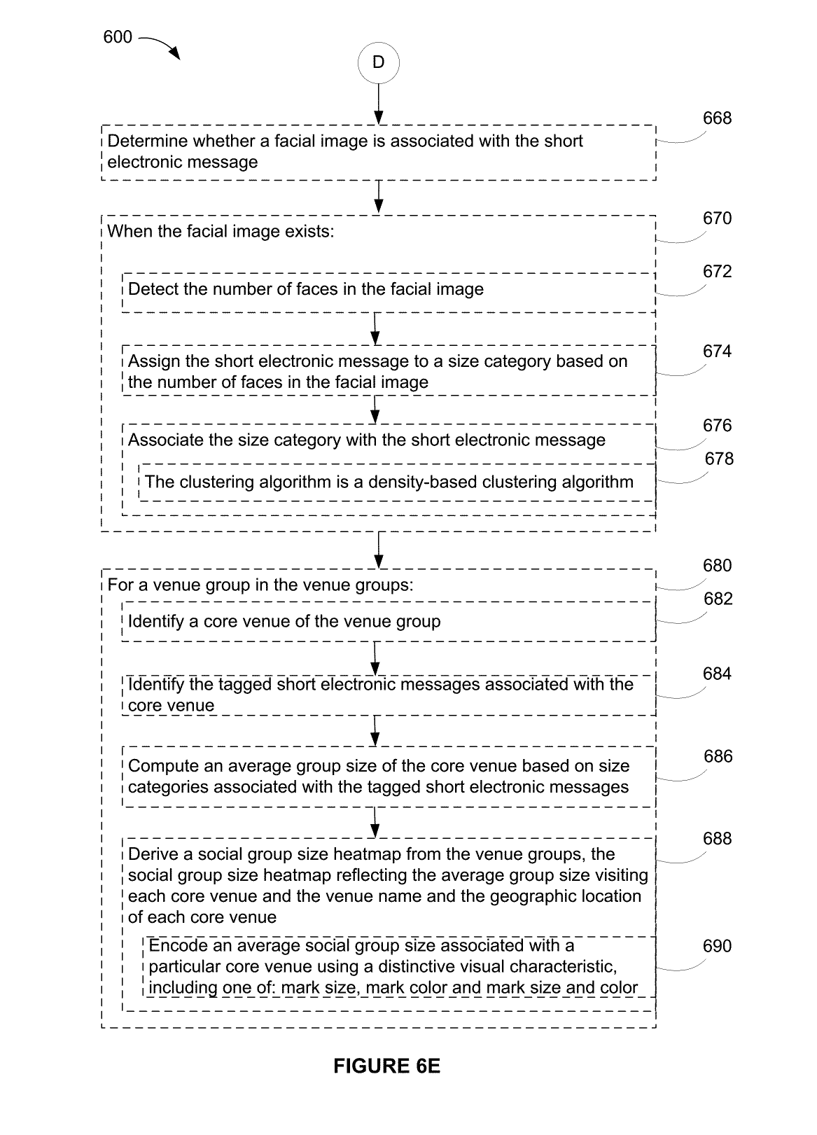

FIG. 6A illustrates a flow diagram of a method 600 for profiling entities in accordance with some implementations. In some implementations, the method 600 is performed at the server system 108. The server 108 obtains (602) from a first social media source a new short unstructured electronic message with an associated geographic location and message content. In some implementations, the obtained short unstructured electronic message along with the associated geographic location is stored in the message database 244, as shown in FIG. 2B. An example of the short unstructured electronic message is a tweet obtained from an external service 122, such as Twitter. In some implementations, the geographic location can be obtained by GPS device on the sensor 312 or the image capture device 308 of the client device 104.

Upon obtaining the short unstructured electronic message, the server 108 identifies (604) a first venue name and a first visit characteristic from the message content. In some implementations, the first characteristic is (606) at least one of a sentiment orientation or a group size. The identified venue name and the associated geographic location can then be used by the server 108 to establish the linkage among the geographic database 242, the message database 244, and the cluster database 246. The linkage is established by the server 108 first accessing (608) a server database 114 of venues, followed by determining (610) whether there is a match in the server database 114 of venues to the new short unstructured electronic message. In some implementations, the server 108 accesses (608) the geographic database 242. As shown in FIG. 2B, in some implementations, the geographic database 242 database includes for respective venues a venue name 254, a geographic location 252 and one or more venue characteristics, such as the number of check-ins 256, the number of unique visitors, and the core venue indicator 260, among others.

As further shown in FIG. 2B, the information in the server database of venues 114 reflects information associated with the respective venues extracted from a plurality of social media posts, including a plurality of prior short unstructured electronic messages from the first social media source. For example, the venue name 266 and the geographic location 262 of a venue are extracted from messages content 264 stored in the message database 244.

In some implementations, following the accessing (608) step, the server determines (610) whether the database 114 includes a candidate venue that has a venue name and geographic location that respectively are substantially similar to the first venue name and the associated geographic location. In some implementations, the venue name and the geographic location are obtained from the geographic database 242 and/or the message database 244. In some implementations, the determination (610) includes determining (612) whether the distance between the respective geographic location 252 and the associated geographic location 262 is less than a predetermined distance. In some implementations, the Great Circle Distance was used for computing distances, and an example predetermined distance requires that the tweets to be within 0.0008 degrees, or about 290 ft, from the venue.

Upon a determination that the candidate exists in the server database 114, the server 108 associates (614) the new short unstructured electronic message with the candidate venue. Upon a determination that the candidate does not exist in the server database 114, the server 108 adds (624) a new venue record to the database 114 based on the first venue name, the associated geographic location and the first characteristic.

Once a number of new short unstructured electronic messages are accumulated such as, when venue records in the database 114 are associated with more than a threshold number of new short unstructured electronic messages, the server 108 updates (616) the one or more venue characteristics of the venue records based on the first visit characteristics of the associated new short unstructured electronic messages. As shown in FIG. 2B, the one or more venue characteristics of the venue records include the overall sentiment 284 and the average group size 286, based on the first characteristics 268 of the associated short unstructured electronic messages.

In some implementations, the updates (616) are performed venue by venue. For example, when profiling an entity such as Starbucks, the updating is performed on venue records associated with Starbucks. In another round of updates, venue records associated with McDonald's can be updated for profiling different locations of McDonald's stores.

In some implementations, the server 108 updates (616) the one or more venue characteristics by first accessing (618) the database of venues, followed by locating (620) core venues in the database and recalculating (622) the one or more venue characteristics of the core venues to include the first characteristics of the associated new short unstructured electronic messages. As shown in FIG. 2B, the geographic database 242 includes for respective venues a venue name 254, a geographic location 252 and one or more venue characteristics. In some implementations, the one or more venue characteristics stored in the geographic database 242 include 614 the number of check-ins 256, the number of unique visitors 258, and the core venue indicator 260 obtained from an external service 122, such as Foursquare, among others. As further shown in FIG. 2B, the information in the server database 114 reflects information associated with the respective venues extracted from a plurality of social media posts, including a plurality of prior short unstructured electronic messages from the first social media source.

In some implementations, to establish records in the server database 114 for profiling entities, as a preliminary operation (626), the server 108 obtain (628) from a first information source a first plurality of short unstructured electronic messages, each having an associated first geographic location and message content, wherein the message content includes the first venue name and one or more visit characteristics. For example, when the first information source is an external service 122, such as Twitter, the plurality of short unstructured electronic messages are tweets downloaded from Twitter. These short unstructured electronic messages are associated with the first geographic location (e.g., geo-tagged) and have message content mention a venue name and one or more visit characteristics, such as opinions about the visit of the venue location and/or photos taken during the visit.

In some implementations, during the preliminary operation 626, the server 108 also obtains (630) from a second information source a second plurality of venue locations, each having an associated second geographic location and second venue name that is substantially similar to the first venue name. For example, during a profiling of Starbucks, the server 108 connects to the external service 122 such as Foursquare as the second information source to download a plurality of venue locations that have venue names substantially similar to Starbucks.

In some implementations, once the short unstructured electronic messages are obtained from the first information source and the venues are obtained from the second information source, the server 108 determines (631) for each venue location in the second plurality whether each respective short message in the first plurality has an associated first geographic location that is within a predefined distance of the second geographic location associated with the each venue location. In some implementations, the Great Circle Distance was used for computing distances, and an example predetermined distance requires that the tweets to be within 0.0008 degrees, or about 290 ft, from the venue.

In some implementations, in response to the determining (631), the server 108 associates (632) with a venue in the database 114 respective short messages and venue locations whose associated first and second geographic locations are within the predefined distance. And the server 108 applies (634) a clustering algorithm to the database to cluster the venues into venue groups and filter out outliers, wherein the outliers represent one or more venues in the database that have one or more aggregate characteristics that are substantially different from corresponding aggregate characteristics of other venues in the database. The clustering combines multiple venues associated with a single store and also filter out fake venues. In some implementations, the server 108 applies (634) a density-based clustering algorithm to the geographic database 242 to cluster the venues into venue groups and filter out outliers that have less than a predetermined number of neighbor points. In some implementations, the one or more aggregate characteristics includes (636) one or more of: a minimum number of visitors to the venue or a minimum number of short messages associated with the venue. For example, the outliers samples may be due to fake Foursquare venues with less than a minimum number of check-ins and/or non-popular locations with less than a minimum number of unique visitors and/or users mentioning a venue when they are somewhere else. The result clusters 280 are stored in the cluster database 246.

Once the clusters 280 are established, the server 108 identifies (638) a core venue that has the most number of check-ins in the venue group. The venue record in the geographic database 242 corresponding to the core venue is then updated (640). The updated (640) core venue indicator 260 indicates the venue record is a core venue. In some implementations, additional information for cross referencing, such as a cluster identifier, is also stored in the geographic database 242 and/or the cluster database 246 to associate a cluster with venue records that belong to the cluster. Following the linkage between the geographic database 242 and the message database 244, the server 108 further tags (644) short electronic messages associated with one or more venues in the venue group with the core venue and updates (646) the core venue record corresponding to the core venue based on the first characteristics of the associated short unstructured electronic messages.

The clusters 280 can be used for profiling of entities. In some implementations, one type of profiling is to calculate an average sentiment expressed by customers for an entity location. In order to calculate the average sentiment, the server 108 assigns (648) sentiment orientations 272 to the message content 264 that recites comments about the venues, the sentiment orientations 272 indicating whether the message content 264 reflects a positive, neutral, or negative sentiment. The server 108 further classifies (650) sentiment degree within a particular sentiment orientation.

The computed sentiment score is associated (654) with the short electronic message and stored in the message database 244 as the sentiment 272 and used for an overall sentiment score calculation. To calculate the overall sentiment score of a cluster, for a venue group in the venue groups (656), the server 108 first identifies (658) a core venue of the venue group. Following the linkage from the cluster database 246 to the geographic database 242, then to the message database 244, the server 108 further identifies (660) the tagged short electronic messages associated with the core venue. Using the sentiment scores 272 stored in the message database 244, the server 108 computes (662) an overall sentiment 284 of the core venue based on sentiment scores 272 associated with the tagged short electronic messages. In some implementations, the server 108 generates a visual presentation of the overall sentiment score by deriving (664) a sentiment heatmap from the venue groups, the sentiment heatmap reflecting the overall sentiment towards each core venue and the venue name and the geographic location of each core venue. FIGS. 5A-5B illustrate example sentiment heatmaps. As shown in FIGS. 5A-5B, the server 108 encodes (666) an overall sentiment associated with a particular core venue using a distinctive visual characteristic, including one of: mark size, mark color and mark size and color.

In some implementations, another type of profiling is to compute the size of the social groups as estimated by the photos people take at a location. In order to calculate the size of the social groups, the server 108 first determines (668) whether a facial image 270 is associated with the short electronic message. When the facial image 270 exists (670), the server 108 detects (672) the number of faces in the facial image 270. The server 108 further assigns (674) the short electronic message to a size category based on the number of faces in the facial image 270. The size category information is associated (676) with the short unstructured electronic message and stored in the message database 244 as the group size 274. For example, when there was at least one face in a facial image 270, the number of faces were quantized into one of four categories (678): single (1 face), pair (2 faces), small group (3-6 faces) and larger group (at least 7 faces), and mapped to a group size code of 1, 2, 3, or 4, respectively. These codes are used when computing average group size for the example heatmaps as shown in FIG. 5C.

To calculate the average group size of a cluster, for a venue group in the venue groups (680), the server 108 first identifies (682) a core venue of the venue group. Following the linkage from the cluster database 246 to the geographic database 242, then to the message database 244, the server 108 further identifies (684) the tagged short electronic messages associated with the core venue. Using the group size 274 stored in the message database 244, the server 108 computes (686) an average group size 286 of the core venue based on the group sizes 274 associated with the tagged short electronic messages. In some implementations, the server 108 generates a visual presentation of the average group size by deriving (688) a social group size heatmap from the venue groups, the social group size heatmap reflecting the average group size visiting each core venue and the venue name and the geographic location of each core venue. As shown in FIG. 5C, the server 108 encodes (690) an average social group size associated with a particular core venue using a distinctive visual characteristic, including one of: mark size, mark color and mark size and color.

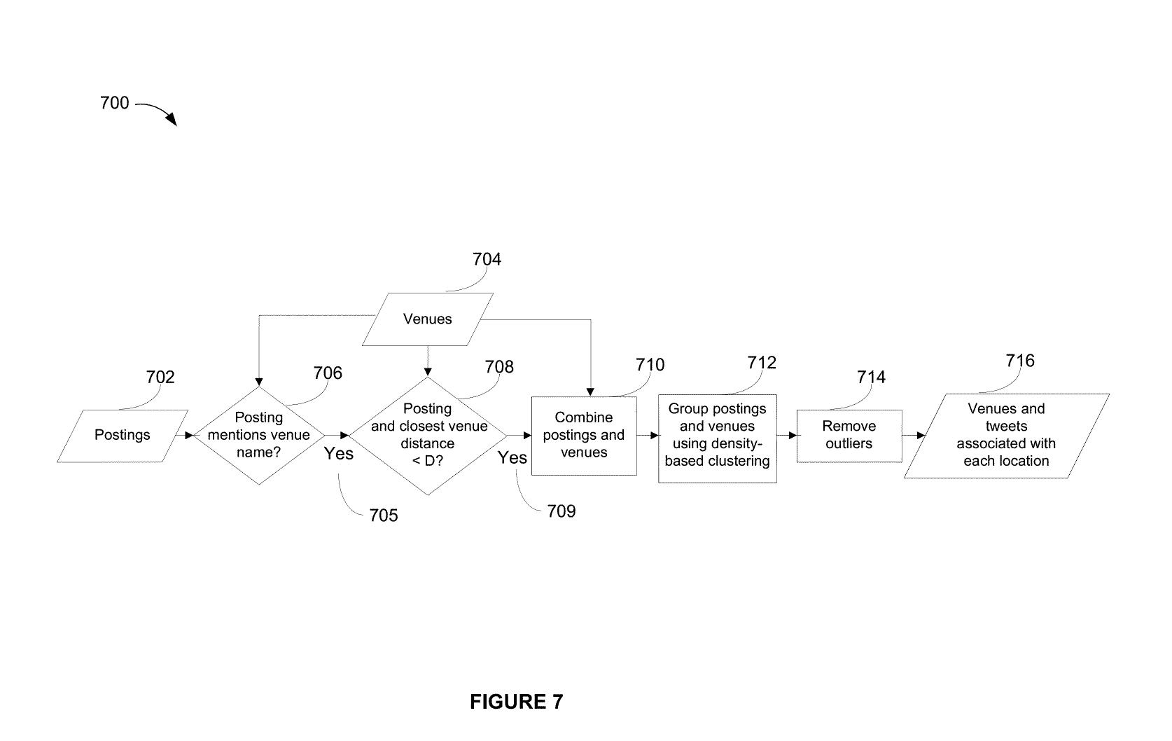

When the clusters 280 are established for the first time for profiling venues, the server 108 obtains the profiling data from one or more external services 122. FIG. 7 illustrates a method for profiling venues in accordance with some implementations. The flowchart of FIG. 7 shows steps as described in Profiling process 1 above. Initially the profiling results, the venueTweets, and the candTweets are set to empty as shown in Profiling Process 1 steps 1-3.

As shown in FIG. 7, in some implementations, the server 108 obtains (702) from one or more external services 122 a plurality of postings. In addition to obtaining (702) postings, the server 108 also obtains (704) from one or more external services 122 a plurality of venues. To reduce the number of queries to the external services 122, the postings and/or the venues are cached and stored in the server database 114 in accordance with some implementations.

For example, as shown in Profiling Process 1, a user may want to profile a user-specified venue u, such as Starbucks. In order to profile Starbucks, postings, such as a set of geo-tagged tweets obtained by the server 108 from the external services 122 are stored in T and a set of geo-tagged venue locations containing the user-specified venue u are obtained by the server 108 from the external services 122 are stored in V for profiling calculation.

Having obtained the data from external services 122, the server 108 then uses the venues information and processes the postings to determine (706) if a posting mentions the venue name. Those postings that do not mention the venue name are not useful for profiling, thus are not used for profiling. In accordance with a determination that a posting mentions (705) the venue name, the server 108 further determines (708) whether the geolocation of the posting and a closest venue are close enough to be within a predetermined distance, D. In accordance with a determination that the posting and the closest venue are (709) close enough, the server 108 proceeds to combine (710) the postings and the venues. In some implementations, the combining operation (710) is performed by associating the venues and the postings, such as establishing the linkage between the geographic database 242 and the message database 244 as illustrated in FIG. 2B. And the combined venues and postings are clustered (712) to group postings and venues using density-based clustering in accordance with some implementations. Post clustering, outliers are removed (714) and core venues are identified so that venues and tweets are associated (716) with each location corresponding to the core venues.

For example, as shown in steps 4-8 of Profiling Process 1, each tweet in the set of geo-tagged tweets T is analyzed to determine (706) if the user-specified venue (e.g., Starbucks) is mentioned in the tweet. In accordance with a determination that a posting mentions (705) the venue name, then the tweet is stored in the venueTweets data set for further processing. Those postings that do not mention the venue name are not useful for profiling, thus are not used for profiling. Further as shown in steps 9-15 of Profiling Process 1, having obtained the set of venueTweets that includes tweets mentioning the user-specified venue (e.g., Starbucks), the server 108 further determines (708) for a each venue in V and for each tweet in venueTweets, whether the distance between the geolocation of the posting and a closest venue are less than D. In accordance with a determination that the posting and the closest venue are (709) close enough, the server 108 proceeds to add the tweet to candTweet data set. The candTweet data set thus has tweets that are in close proximity of venues of interest. The server 108 then combines (710) the candTweet and the venues data set V in step 16 of Profiling Process 1 for clustering.

In step 16 of Profiling Process 1, a clustering algorithm, such as density-based clustering DBScan can be used to group (712) postings and venues. In some implementations, a minimum of five neighbors per point are specified as a parameter to the DBScan algorithm. Outliers are removed (714) in step 17 of Profiling Process 1. For example, a tweet in candTweet mentions a non-popular location that have less than four other tweets mentioning the same location. Such a tweet is removed (714) due to less than five neighbors. In another example, the user posted the tweet mentioning the venue when he is somewhere else. Such a tweet is also removed (714) since the geolocation of the tweet is substantially different from the aggregate characteristics of other venues and the tweets.

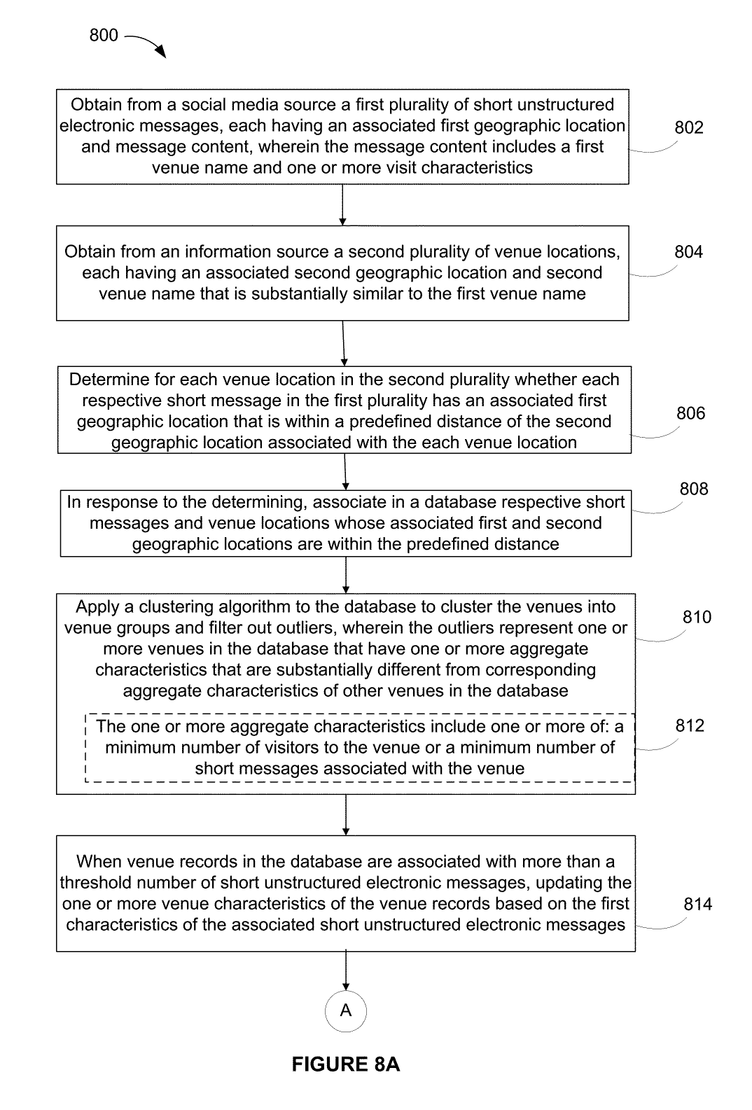

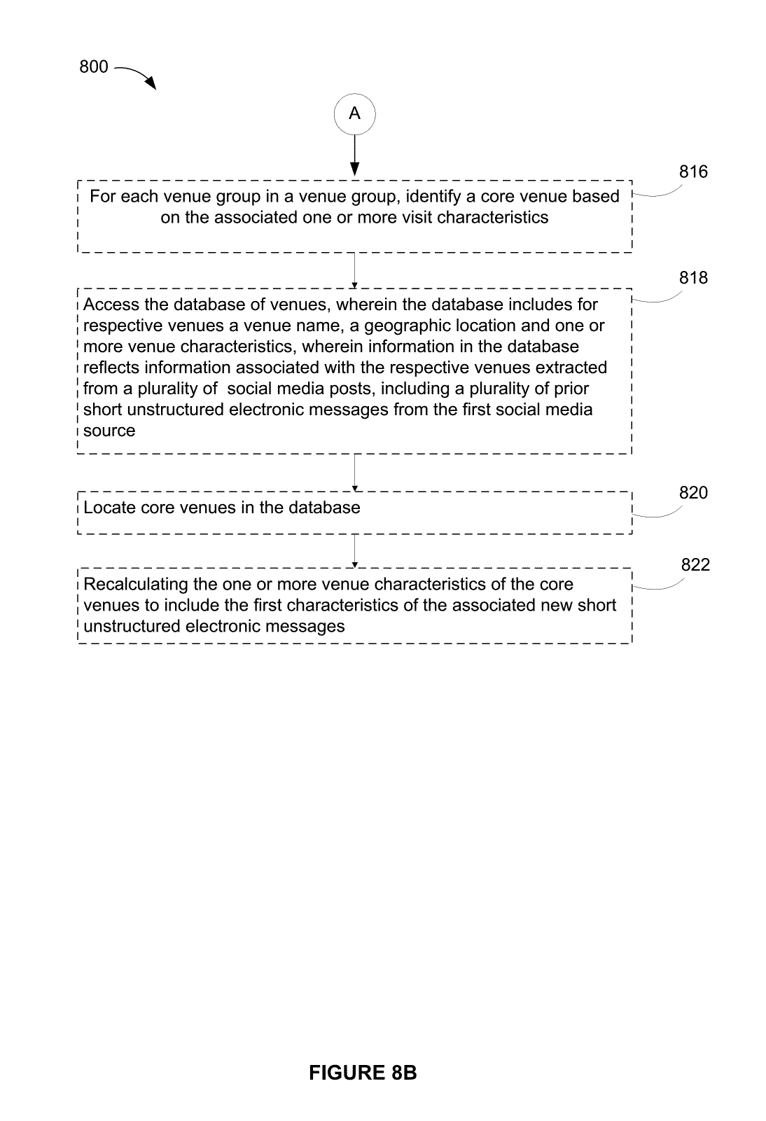

FIG. 8A illustrates a flow diagram of a method 800 for profiling venues in accordance with some implementations. In some implementations, the method 800 is performed at the server system 108. The server 108 obtains (802) from a social media source a first plurality of short unstructured electronic messages, each having an associated first geographic location and message content, wherein the message content includes a first venue name and one or more visit characteristics. The server 108 then obtains (804) from an information source a second plurality of venue locations, each having an associated second geographic location and second venue name that is substantially similar to the first venue name. In some implementations, the obtained short unstructured electronic message along with the associated geographic location is stored in the message database 244, as shown in FIG. 2B. An example of the short unstructured electronic message is a tweet obtained from an external service 122, such as Twitter. In some implementations, the geographic location can be obtained by GPS device on the sensor 312 or the image capture device 308 of the client device 104.

Upon obtaining the short unstructured electronic messages and the venue locations, the server 108 determines (806) for each venue location in the second plurality whether each respective short message in the first plurality has an associated first geographic location that is within a predefined distance of the second geographic location associated with the each venue location. In some implementations, in response to the determining (806), the server 108 associates (808) in a database respective short messages and venue locations whose associated first and second geographic locations are within the predefined distance. The server 108 then applies (810) a clustering algorithm to the database to cluster the venues into venue groups and filter out outliers, wherein the outliers represent one or more venues in the database that have one or more aggregate characteristics that are substantially different from corresponding aggregate characteristics of other venues in the database. The clustering combines multiple venues associated with a single store and also filter out fake venues. In some implementations, the one or more aggregate characteristics include one or more of: a minimum number of visitors to the venue or a minimum number of short messages associated with the venue.

Once venue records in the database 114 are associated with more than a threshold number of new short unstructured electronic messages, the server 108 updates (814) the one or more venue characteristics of the venue records based on the first visit characteristics of the associated new short unstructured electronic messages. As shown in FIG. 2B, the one or more venue characteristics of the venue records include the overall sentiment 284 and the average group size 286, based on the first characteristics 268 of the associated short unstructured electronic messages.

In some implementations, once the clusters 280 are established, the server 108 identifies (816) a core venue that has the most number of check-ins in the venue group. The venue record in the geographic database 242 corresponding to the core venue is then updated (640). The updated (640) core venue indicator 260 indicates the venue record is a core venue.

In some implementations, the server further accesses (818) the database of venues, wherein the database includes for respective venues a venue name, a geographic location and one or more venue characteristics, information in the database reflects information associated with the respective venues extracted from a plurality of social media posts, including a plurality of prior short unstructured electronic messages from the first social media source. In some implementations, the server 108 locates (820) core venues in the database and recalculates (822) the one or more venue characteristics of the core venues to include the first characteristics of the associated new short unstructured electronic messages.

It will be understood that, although the terms “first,” “second,” etc. may be used herein to describe various elements, these elements should not be limited by these terms. These terms are only used to distinguish one element from another. For example, a first contact could be termed a second contact, and, similarly, a second contact could be termed a first contact, which changing the meaning of the description, so long as all occurrences of the “first contact” are renamed consistently and all occurrences of the second contact are renamed consistently. The first contact and the second contact are both contacts, but they are not the same contact.

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Reference will now be made in detail to various embodiments, examples of which are illustrated in the accompanying drawings. In the following detailed description, numerous specific details are set forth in order to provide a thorough understanding of the invention and the described embodiments. However, the invention may be practiced without these specific details. In other instances, well-known methods, procedures, components, and circuits have not been described in detail so as not to unnecessarily obscure aspects of the embodiments.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method, comprising:
at a computer system with one or more processors and memory storing instructions for execution by the processor:
obtaining from a first social media source a new short unstructured electronic message with an associated geographic location and message content;
identifying a first venue name and a first visit characteristic from the message content;
accessing a database of venues, wherein the database includes for respective venues a venue name, a geographic location and one or more venue characteristics, wherein information in the database reflects information associated with the respective venues extracted from a plurality of social media posts, including a plurality of prior short unstructured electronic messages from the first social media source;
determining whether the database includes a candidate venue that has a venue name and geographic location that respectively are substantially similar to the first venue name and the associated geographic location;
when the candidate venue exists in the database, associating the new short unstructured electronic message with the candidate venue; and
when venue records in the database are associated with more than a threshold number of new short unstructured electronic messages, updating the one or more venue characteristics of the venue records based on the first visit characteristics of the associated new short unstructured electronic messages.

2. The method of claim 1, further comprising:
when the candidate venue does not exist in the database, adding a new venue record to the database based on the first venue name, the associated geographic location and the first characteristic.

3. The method of claim 1, wherein the first visit characteristic is at least one of a sentiment orientation or a group size.

4. The method of claim 1, wherein determining whether the database includes a candidate venue that has a venue geographic location that is substantially similar to the associated geographic location; includes:
determining whether distance between the venue geographic location and the associated geographic location is less than a predetermined distance.

5. The method of claim 1, wherein the database includes for a respective venue a number of check-ins, a number of unique visitors, and a core venue indicator, further comprising as a preliminary operation:
obtaining from a first information source a first plurality of short unstructured electronic messages, each having an associated first geographic location and message content, wherein the message content includes the first venue name and one or more visit characteristics;
obtaining from a second information source a second plurality of venue locations, each having an associated second geographic location and second venue name that is substantially similar to the first venue name;
determining for each venue location in the second plurality whether each respective short message in the first plurality has an associated first geographic location that is within a predefined distance of the second geographic location associated with the each venue location;
in response to the determining, associating with a venue in the database respective short messages and venue locations whose associated first and second geographic locations are within the predefined distance;
applying a clustering algorithm to the database to cluster the venues into venue groups and filter out outliers, wherein the outliers represent one or more venues in the database that have one or more aggregate characteristics that are substantially different from corresponding aggregate characteristics of other venues in the database;
identifying for each venue group a core venue that has most number of check-ins in the venue group; and
updating the core venue indicator for the core venue.

6. The method of claim 5, wherein updating the core venue record based on the first characteristics of the associated short unstructured electronic messages includes:
for a venue group in the venue groups:
tagging the associated short unstructured electronic messages with the core venue; and
updating the core venue record corresponding to the core venue based on the first characteristics of the associated short unstructured electronic messages.

7. The method of claim 5, further comprising:
assigning sentiment orientations to the message content that recites comments about of the venues, the sentiment orientations indicating whether the message content reflects a positive, neutral, or negative sentiment;
classifying sentiment degree within a particular sentiment orientation;
computing a sentiment score based on the sentiment orientations; and
associating the sentiment score with the short unstructured electronic message.

8. The method of claim 7, further comprising:
for a venue group in the venue groups:
identifying the core venue of the venue group;
identifying the tagged short unstructured electronic messages associated with the core venue;
computing an overall sentiment of the core venue based on sentiment scores associated with the tagged short unstructured electronic messages; and
deriving a sentiment heatmap from the venue groups, the sentiment heatmap reflecting the overall sentiments towards each core venue and the venue name and the geographic location of each core venue.

9. The method of claim 8, wherein deriving the sentiment heatmap includes:
encoding an overall sentiment associated with a particular core venue using a distinctive visual characteristic, including one of: mark size, mark color and mark size and color.

10. The method of claim 5, further comprising:
determining whether a facial image is associated with the short unstructured electronic message;
when the facial image exists:
detecting the number of faces in the facial image;
assigning the short unstructured electronic message to a size category based on the number of faces in the facial image; and
associating the size category with the short unstructured electronic message.

11. The method of claim 10, wherein the clustering algorithm is a density-based clustering algorithm.

12. The method of claim 10, further comprising:
for a venue group in the venue groups:
identifying a core venue of the venue group;
identifying the tagged short unstructured electronic messages associated with the core venue;
computing an average group size of the core venue based on size categories associated with the tagged short unstructured electronic messages; and
deriving a social group size heatmap from the venue groups, the social group size heatmap reflecting the average group size visiting each core venue and the venue name and the geographic location of each core venue.

13. The method of claim 12, wherein deriving the social group size heatmap includes:
encoding an average social group size associated with a particular core venue using a distinctive visual characteristic, including one of: mark size, mark color and mark size and color.

14. The method of claim 5, wherein the one or more aggregate characteristics include one or more of: a minimum number of visitors to the venue or a minimum number of short messages associated with the venue.

15. The method of claim 1, wherein updating the one or more venue characteristics includes:
accessing the database of venues, wherein the database includes for respective venues a venue name, a geographic location and one or more venue characteristics, wherein information in the database reflects information associated with the respective venues extracted from a plurality of social media posts, including a plurality of prior short unstructured electronic messages from the first social media source;
locating core venues in the database; and
recalculating the one or more venue characteristics of the core venues to include the first characteristics of the associated new short unstructured electronic messages.

16. A method of profiling venues, comprising:
obtaining from a social media source a first plurality of short unstructured electronic messages, each having an associated first geographic location and message content, wherein the message content includes a first venue name and one or more visit characteristics;
obtaining from an information source a second plurality of venue locations, each having an associated second geographic location and second venue name that is substantially similar to the first venue name;
determining for each venue location in the second plurality whether each respective short message in the first plurality has an associated first geographic location that is within a predefined distance of the second geographic location associated with the each venue location;
in response to the determining, associating in a database respective short messages and venue locations whose associated first and second geographic locations are within the predefined distance; and
applying a clustering algorithm to the database to cluster the venues into venue groups and filter out outliers, wherein the outliers represent one or more venues in the database that have one or more aggregate characteristics that are substantially different from corresponding aggregate characteristics of other venues in the database; and
when venue records in the database are associated with more than a threshold number of short unstructured electronic messages, updating the one or more venue characteristics of the venue records based on the first characteristics of the associated short unstructured electronic messages.

17. The method of claim 16, wherein the one or more aggregate characteristics include one or more of: a minimum number of visitors to the venue or a minimum number of short messages associated with the venue.

18. The method of claim 16, further comprising: for each venue group in a venue group, identifying a core venue based on the associated one or more visit characteristics.

19. The method of claim 16, further comprising:
accessing the database of venues, wherein the database includes for respective venues a venue name, a geographic location and one or more venue characteristics, wherein information in the database reflects information associated with the respective venues extracted from a plurality of social media posts, including a plurality of prior short unstructured electronic messages from the first social media source;
locating core venues in the database; and
recalculating the one or more venue characteristics of the core venues to include the first characteristics of the associated new short unstructured electronic messages.

20. A computer system, comprising:
one or more processors;
memory; and
one or more programs, wherein the one or more programs are stored in the memory and configured to be executed by the one or more processors, the one or more programs including instructions for:
obtaining from a first social media source a new short unstructured electronic message with an associated geographic location and message content;
identifying a first venue name and a first visit characteristic from the message content;
accessing a database of venues, wherein the database includes for respective venues a venue name, a geographic location and one or more venue characteristics, wherein information in the database reflects information associated with the respective venues extracted from a plurality of social media posts, including a plurality of prior short unstructured electronic messages from the first social media source;
determining whether the database includes a candidate venue that has a venue name and geographic location that respectively are substantially similar to the first venue name and the associated geographic location;
when the candidate venue exists in the database, associating the new short unstructured electronic message with the candidate venue; and
when venue records in the database are associated with more than a threshold number of new short unstructured electronic messages, updating the one or more venue characteristics of the venue records based on the first visit characteristics of the associated new short unstructured electronic messages.
